(19) United States
(12) Patent Application Publication
(10) Pub. No.: US 2026/0213447 A1
(43) Pub. Date: Jul. 23, 2026

(54) ELECTRICAL CONNECTOR

(71) Applicant: LOTES CO., LTD, Keelung (TW)

(72) Inventors: Chang-Wei Huang, Guangzhou (CN); Kai-Quan Zhou, Guangzhou (CN); Jia-Ren Duan, Guangzhou (CN)

(21) Appl. No.: 19/455,995

(22) Filed: Jan. 22, 2026

(30) Foreign Application Priority Data
Jan. 23, 2025 (CN) 202510112553.4
Jan. 25, 2025 (CN) 202510123215.0
May 12, 2025 (CN) 202520927970.X

(51) Int. Cl. H01R 13/05; H01R 12/70; H01R 12/71

(52) U.S. Cl. CPC H01R 13/05; H01R 12/7076; H01R 12/712

(57) ABSTRACT

An electrical connector includes an insulating main body and terminals. Each terminal includes an upper elastic portion. An upper end of the upper elastic portion has an upper contact portion upwardly abutting against a first mating member. An upper extending portion is formed by bending and extending downward from the upper contact portion. An upper abutting portion is formed at an end portion of the upper extending portion away from the upper contact portion. An upper supporting portion is located below the upper contact portion. When the first mating member abuts against the upper contact portion, the upper abutting portion abuts against the upper supporting portion.

### CROSS-REFERENCE TO RELATED PATENT APPLICATION

This non-provisional application claims priority to and the benefit of, pursuant to 35 U.S.C. § 119(a), patent application Serial No. CN202510112553.4, filed in China on Jan. 23, 2025, patent application Serial No. CN202510123215.0, filed in China on Jan. 25, 2025, and patent application Serial No. CN202520927970.X, filed in China on May 12, 2025. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector having a plurality of conductive paths.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing electrical connector is used to upwardly mate with a mating member. The electrical connector includes a plurality of terminals. Each terminal includes a body portion and an elastic arm and a fixing arm extending from an upper end of the body portion. The elastic arm is provided with a slot, and the slot runs through the elastic arm and extends to the body portion. A free end of the elastic arm in its extending direction is provided with a contact portion. The fixing arm includes an extending portion extending vertically and an abutting portion extending obliquely from an upper end of the extending portion. The elastic arm abuts upwardly against the mating member, and the elastic arm, after being pressed by the mating member and deforming, abuts against the abutting portion. In the extending direction of the elastic arm, an abutting position of the elastic arm and the abutting portion is located in front of the slot and behind the contact portion.

However, the elastic arm, after being pressed and deforming, abuts against the abutting portion, and the elastic arm may slide along the abutting portion. The abutting position of the elastic arm and the abutting portion is located in front of the slot and behind the contact portion. Thus, deviation may easily occur between the elastic arm and the abutting portion, and the extending portion, which extends vertically, is prone to deformation, which may result in unstable contact or even no contact between the elastic arm and the fixing arm, thereby affecting the performance of each terminal.

Therefore, a heretofore unaddressed need to design an electrical connector exists in the art to address the aforementioned deficiencies and inadequacies.

### SUMMARY

The present invention is directed to an electrical connector, an electrical connector with terminals having a plurality of conductive paths and achieving impedance matching.

To achieve the foregoing objective, the present invention adopts the following technical solution:

An electrical connector includes: a main body, comprising a plurality of accommodating slots running through the main body along a vertical direction; and a plurality of terminals, respectively accommodated correspondingly in the accommodating slots. Each of the terminals includes: an upper elastic portion, wherein a top portion of the upper elastic portion has an upper contact portion, and the upper contact portion is configured to upwardly abut against a first mating member; an upper through slot, at least partially located in the upper elastic portion, such that the upper elastic portion forms two upper branches separated by the upper through slot in a left-right direction; an upper extending portion, formed by bending and extending downward from the upper contact portion, wherein an upper abutting portion is formed at an end portion of the upper extending portion away from the upper contact portion; and an upper supporting portion, located below the upper contact portion, wherein when the first mating member abuts downward against the upper contact portion, the upper abutting portion abuts against the upper supporting portion. A projection of the upper abutting portion in a front-rear direction is located in the upper through slot, such that the upper through slot is reserved for the upper abutting portion.

To achieve the foregoing objective, the present invention further adopts the following technical solution:

An electrical connector includes: a main body, comprising a plurality of accommodating slots running through the main body along a vertical direction; and a plurality of terminals, respectively accommodated correspondingly in the accommodating slots. Each of the terminals includes: a body portion, provided in a corresponding one of the accommodating slots; an upper elastic portion, formed by extending upward from the body portion, wherein a top portion of the upper elastic portion has an upper contact portion, the upper contact portion is located in front of the body portion, and the upper contact portion is configured to upwardly abut against a first mating member; an upper extending portion, formed by bending and extending downward from the upper contact portion, wherein an upper abutting portion is formed at an end portion of the upper extending portion away from the upper contact portion; an upper through slot, provided at least in the upper elastic portion; an upper supporting portion, formed by extending from a bottom portion of the upper through slot, wherein when the first mating member abuts downward against the upper contact portion, the upper abutting portion abuts against the upper supporting portion; a lower elastic portion, formed by extending downward from the body portion, wherein a bottom portion of the lower elastic portion has a lower contact portion, the lower contact portion is located in front of the body portion, and the lower elastic portion is configured to downwardly abut against a second mating member; a lower extending portion, formed by bending and extending upward from the lower contact portion, wherein a lower abutting portion is formed at an end portion of the lower extending portion away from the lower contact portion; a lower through slot, provided at least in the lower elastic portion; and a lower supporting portion, extending from a top portion of the lower through slot, wherein when the second mating member abuts upward against the lower contact portion, the lower abutting portion abuts against the lower supporting portion. Each of the upper supporting portion and the lower supporting portion at least partially extends in the front-rear direction relative to the body portion, the body portion comprises a connecting portion, an upper end of the connecting portion is connected to the upper supporting portion, a lower end of the connecting portion is connected to the lower supporting portion, and the connecting portion is a continuous plate-shaped structure.

To achieve the foregoing objective, the present invention further adopts the following technical solution:

An electrical connector includes: a main body, comprising a plurality of accommodating slots running through the main body along a vertical direction; and a plurality of terminals, respectively accommodated correspondingly in the accommodating slots. Each of the terminals includes: a body portion, fixed in a corresponding one of the accommodating slots; an upper elastic portion, formed by extending upward from the body portion, wherein a top portion of the upper elastic portion has an upper contact portion, the upper contact portion is located in front of the body portion, and the upper contact portion is configured to upwardly abut against a first mating member; an upper through slot, provided at least in the upper elastic portion, and running through the upper elastic portion so as to divide the upper elastic portion into two upper branches in the left-right direction; an upper extending portion, formed by bending and extending downward from the upper contact portion, wherein an upper abutting portion is formed at an end portion of the upper extending portion away from the upper contact portion; and an upper supporting portion, formed by extending from a bottom portion of the upper through slot, wherein the upper supporting portion is located below the upper contact portion, and when the first mating member abuts downward against the upper contact portion, the upper abutting portion abuts against the upper supporting portion. Each of the terminals is provided with a pushing portion, the pushing portion is provided to be lower than a top portion of the upper through slot and higher than the bottom portion of the upper through slot, the pushing portion is exposed upward in the upper through slot, and the pushing portion is configured to be pushed by a jig so as to adjust a position of each of the terminals in a corresponding one of the accommodating slots.

Compared to the related art, the present invention has the following beneficial effects:

Each terminal has the upper extending portion formed by bending and extending downward from the upper contact portion, and the upper abutting portion is formed at an end of the upper extending portion away from the upper contact portion. The upper supporting portion is located below the upper contact portion. When the first mating member abuts downward against the upper contact portion, the upper abutting portion abuts against the upper supporting portion. Compared with the case where only a single conductive path is provided passing through the upper contact portion and the upper elastic portion, the present invention further provides another conductive path passing through the upper contact portion and the upper supporting portion, thereby reducing the impedance of each terminal and achieving impedance matching. Compared with the case where the upper elastic portion directly abuts against the upper supporting portion, since the upper extending portion, which is capable of elastic deformation, is added between the upper contact portion and the upper supporting portion, when the first mating member presses the upper contact portion downward, the upper extending portion may elastically abut downward against the upper supporting portion, such that the contact between the upper extending portion and the upper supporting portion is stable.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective view of an electrical connector according to a first embodiment of the present invention.

FIG. 2 is a top view of the electrical connector in FIG. 1.

FIG. 3 is a perspective sectional view of the electrical connector in FIG. 2 taken along a line A-A.

FIG. 4 is a sectional view of the electrical connector in FIG. 2 taken along a line B-B when a first mating member and a second mating member abut against the terminal to a final position.

FIG. 5 is a perspective view of the terminal in FIG. 1.

FIG. 6 is a front view of the terminal in FIG. 5.

FIG. 7 is a perspective view of an electrical connector according to a second embodiment of the present invention.

FIG. 8 is a sectional view of the electrical connector in FIG. 7 taken along a line C-C when a jig pushes the terminal.

FIG. 9 is a perspective view of the terminal in FIG. 7.

FIG. 10 is a front view of the terminal in FIG. 9.

FIG. 11 is a partial top view of the electrical connector in FIG. 7.

FIG. 12 is a perspective view of an electrical connector according to a third embodiment of the present invention.

FIG. 13 is a sectional view of the electrical connector in FIG. 12 taken along a line D-D after being mated with a first mating member and a second mating member.

FIG. 14 is a sectional view of the electrical connector in FIG. 12 taken along a line E-E when a jig pushes the terminal.

FIG. 15 is a perspective view of the terminal in FIG. 12 from another angle.

FIG. 16 is a perspective view of the terminal in FIG. 12 from a further angle.

FIG. 17 is a plain view of the terminal in FIG. 12 in an unfolded state.

FIG. 18 is a perspective view of an electrical connector according to a fourth embodiment of the present invention.

FIG. 19 is a partial top view of the electrical connector in FIG. 18.

FIG. 20 is a partial top view the terminal in FIG. 18 when being pressed downward by when the first mating member to a final position.

FIG. 21 is a sectional view of the terminal in FIG. 19 taken along a line F-F when a jig pushes the terminal.

FIG. 22 is a schematic view when the first mating member presses the terminal in FIG. 21 downward to a final position and a second mating member presses the terminal in FIG. 21 upward to a final position.

FIG. 23 is a perspective view of the terminal in FIG. 18 after completely mating with the first and second mating members and from another angle.

FIG. 24 is a top view of the terminal in FIG. 23.

FIG. 25 is a front view of the terminal in FIG. 23.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

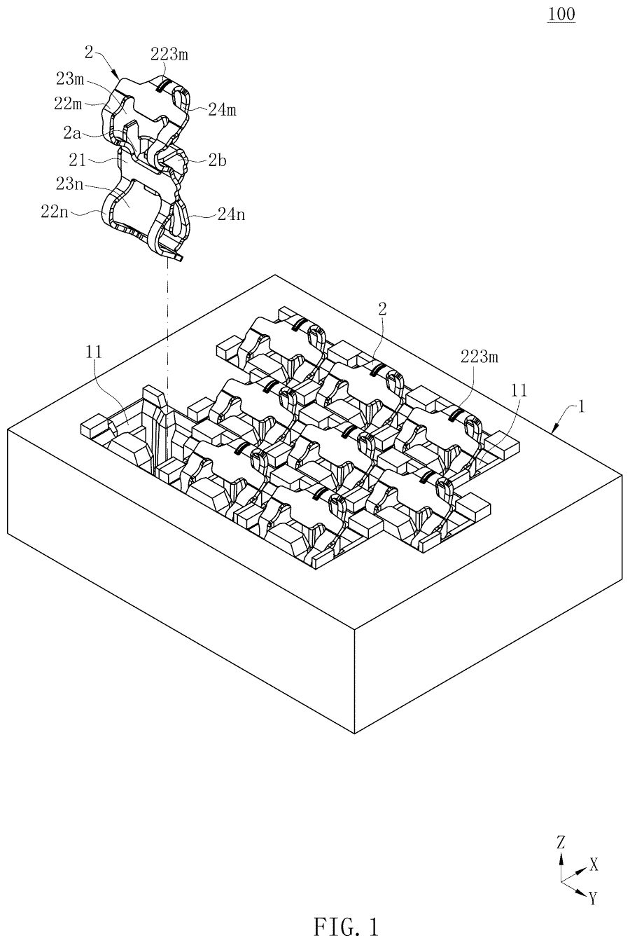

The description will be made as to the embodiments of the present invention in conjunction with the accompanying drawings in FIGS. 1-25. In accordance with the purposes of this invention, as embodied and broadly described herein, this invention, in one aspect, relates to an electrical connector.

For better understanding, in the present invention, an extending direction of the X-axis is defined as a front-rear direction, in which the positive direction of the X-axis is forward. An extending direction of the Y-axis is defined as a left-right direction, in which the positive direction of the Y-axis is rightward. An extending direction of the Z-axis is defined as a vertical direction, in which the positive direction of the Z-axis is upward.

FIGS. 1 to 6 show an electrical connector 100 according to a first embodiment of the present invention. The electrical connector 100 includes a main body 1 and a plurality of terminals 2. The terminals 2 abut upwardly against a first mating member 200, and the first mating member 200 is a chip module. The terminals 2 abut downwardly against a second mating member 300, and the second mating member 300 is a circuit board. The main body 1 is made of an insulating material. In other embodiments, the first mating member 200 may be a circuit board and the second mating member 300 may be a chip module. It is also possible that the main body 1 may be partly made of an insulating material and partly made of a conductive material and/or a wave-absorbing material.

Referring to FIGS. 1, 2 and 4, the main body 1 includes a plurality of accommodating slots 11 running through the main body 1 along the vertical direction. Each terminal 2 is correspondingly accommodated in a corresponding one of the accommodating slots 11. A stopping block 111 protrudes in each accommodating slot 11 of the main body 1.

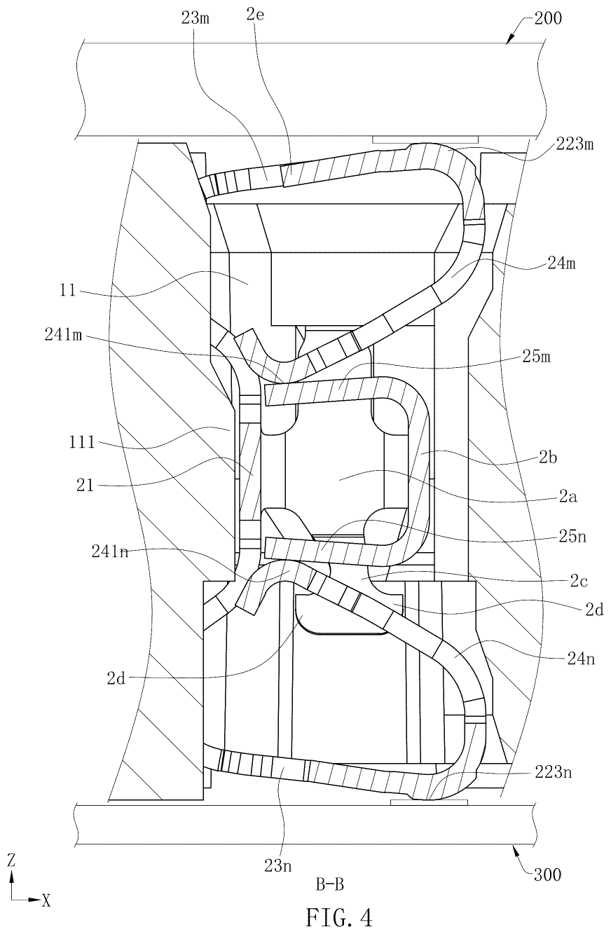

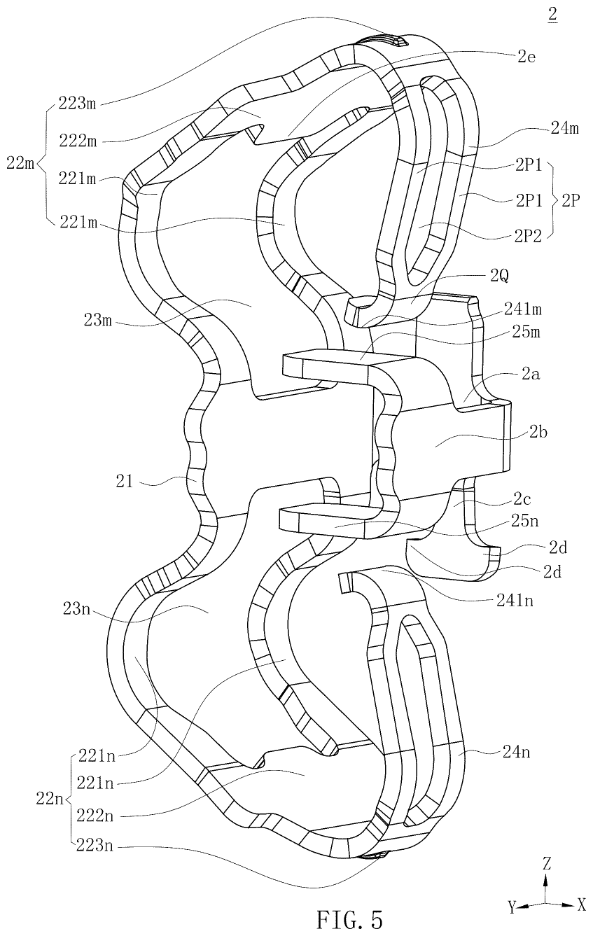

Referring to FIGS. 4 and 5, each terminal 2 includes a base portion 2a, a body portion 21 formed by bending and extending from a rear end of the base portion 2a, and a supporting plate 2b formed by bending and extending from a front end of the base portion 2a. The body portion 21 and the supporting plate 2b match with the corresponding accommodating slot 11 to fix the terminal 2 in the corresponding accommodating slot 11. The body portion 21 and the supporting plate 2b are provided facing each other in the front-rear direction, and a distance between the body portion 21 and the supporting plate 2b may be adjusted according to different impedance requirements, thereby adjusting the impedance and achieving impedance matching.

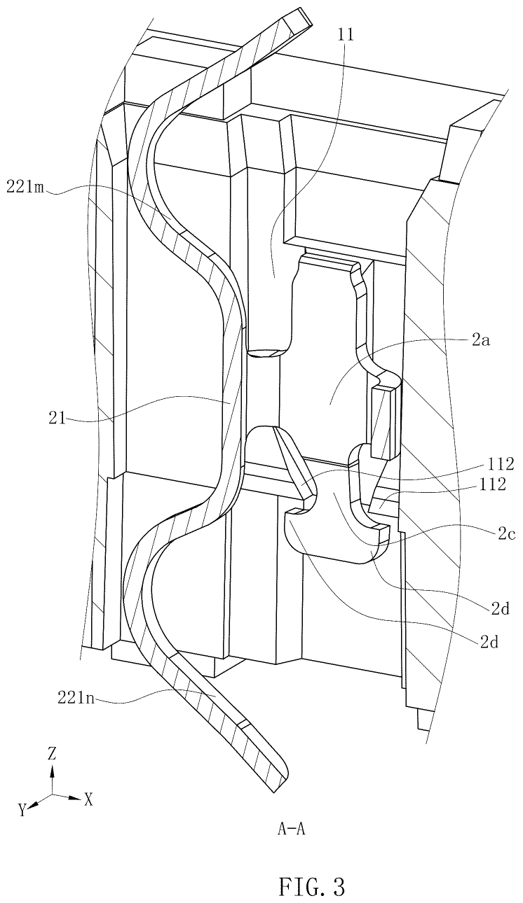

Referring to FIGS. 3, 5 and 6, a guiding portion 2c is formed by obliquely extending from an upper end of the base portion 2a toward a side where the body portion 21 and the supporting plate 2b are located in the left-right direction. In the process where the terminal 2 is mounted into the corresponding accommodating slot 11 upward from bottom, the guiding portion 2c provides a guiding function, thus facilitating assembly of the terminal 2. A hook portion 2d is formed at a tail end of the guiding portion 2c. The main body 1 is provided with two limiting blocks 112 in each accommodating slot 11, and the two limiting blocks 112 are respectively located at a front side and a rear side of the guiding portion 2c. The limiting blocks 112 are located below the hook portion 2d and match with the hook portion 2d to limit the terminal 2 from moving downward. In other embodiments, the guiding portion 2c may be formed by obliquely extending from a lower end of the base portion 2a toward the side where the body portion 21 and the supporting plate 2b are located in the left-right direction, the limiting blocks 112 are located above the hook portion 2d, and the limiting blocks 112 match with the hook portion 2d to limit the terminal 2 from moving upward.

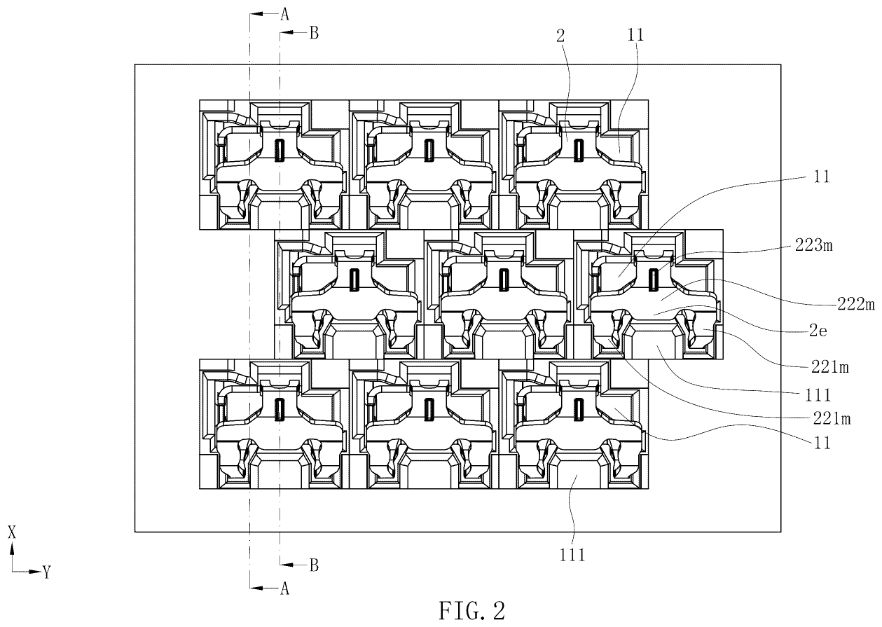

Referring to FIGS. 2, 4 and 5, an upper elastic portion 22m is formed by extending upward from an upper end of the body portion 21. A top portion of the upper elastic portion 22m has an upper contact portion 223m, and the upper contact portion 223m is configured to upwardly abut against the first mating member 200. In the front-rear direction, the upper contact portion 223m is located in front of the body portion 21.

Referring to FIGS. 4 and 5, the upper elastic portion 22m firstly extends upward and backward from the upper end of the body portion 21 and then extends upward and forward. The stopping block 111 is located behind the body portion 21. The stopping block 111 may stop the body portion 21, thus preventing the body portion 21 from moving in the front-rear direction when the first mating member 200 presses the upper contact portion 223m downward.

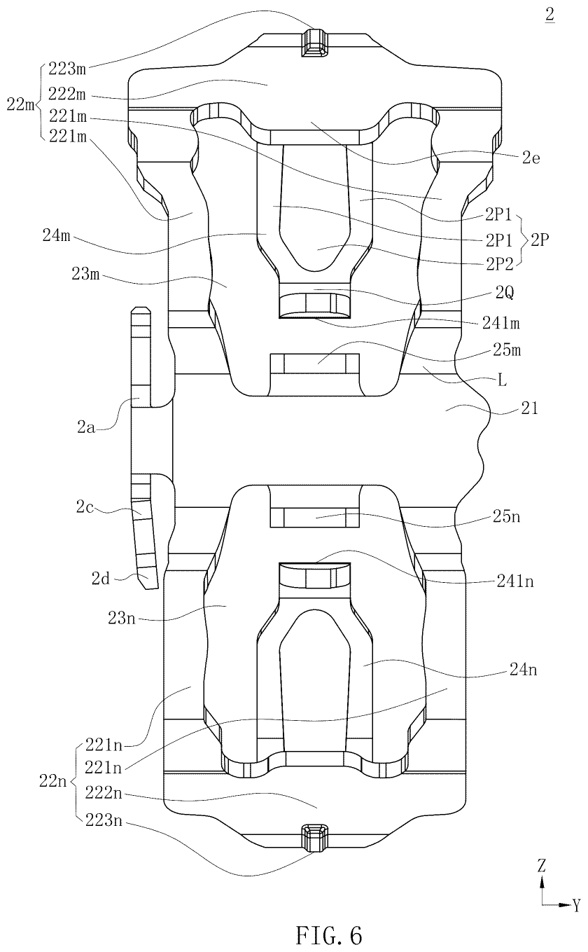

Referring to FIGS. 5 and 6, the upper elastic portion 22m includes two upper branches 221m separated in the left-right direction and an upper shoulder portion 222m connecting top ends of the two upper branches 221m. The upper contact portion 223m is formed by extending from an end of the upper shoulder portion 222m away from the upper branches 221m.

Referring to FIGS. 5 and 6, each terminal 2 includes an upper through slot 23m. The upper through slot 23m runs through the upper elastic portion 22m and is located between the two upper branches 221m and the upper shoulder portion 222m. The upper through slot 23m increases the elasticity of the upper elastic portion 22m, and when the first mating member 200 abuts downward against the upper contact portion 223m, the upper elastic portion 22m bends more easily. In addition, the upper elastic portion 22m is provided with the two upper branches 221m, such that the upper elastic portion 22m forms two conductive paths, and the upper elastic portion 22m has a larger dimension in the left-right direction. Thus, the upper elastic portion 22m has a lower impedance, and thereby achieving impedance matching of the terminal 2.

Referring to FIGS. 4, 5 and 6, the upper shoulder portion 222m protrudes toward the upper through slot 23m to form a protruding portion 2e. The impedance magnitude is inversely proportional to a dimension of the upper shoulder portion 222m. The protruding portion 2e increases the dimension of the upper shoulder portion 222m in the vertical direction, thereby reducing impedance of the upper shoulder portion 222m. Further, when the first mating member 200 abuts downward against the upper contact portion 223m, the upper shoulder portion 222m is close to the first mating member 200, such that the impedance near an abutting position of the upper contact portion 223m and the first mating member 200 is reduced, thereby achieving impedance matching of the terminal 2.

Referring to FIGS. 4, 5 and 6, in the left-right direction, a dimension of the upper shoulder portion 222m is greater than a maximum dimension limited between the two upper branches 221m, such that the impedance of the upper shoulder portion 222m is reduced. When the first mating member 200 abuts downward against the upper contact portion 223m, the upper shoulder portion 222m is close to the first mating member 200, such that the impedance near the abutting position of the upper contact portion 223m and the first mating member 200 is reduced, thereby achieving impedance matching of the terminal 2.

Referring to FIGS. 2 and 4, the stopping block 111 extends into the corresponding upper through slot 23m. The stopping block 111 is located behind the body portion 21, so the capacitance near the body portion 21 is relatively large, and impedance is inversely proportional to capacitance, such that the impedance of the body portion 21 is relatively small. The stopping block 111 extends into the corresponding upper through slot 23m, thus increasing the capacitance near the upper elastic portion 22m, such that the impedance near the upper elastic portion 22m is reduced, thereby achieving impedance matching of the terminal 2.

Referring to FIGS. 4, 5 and 6, an upper extending portion 24m is formed by bending and extending downward from the upper contact portion 223m. The upper extending portion 24m includes a first portion 2P and a second portion 2Q. In the left-right direction, a dimension of the first portion 2P is greater than a dimension of the second portion 2Q. The first portion 2P includes two sub-portions 2P1 separated in the left-right direction and an upper slot 2P2 located between the two sub-portions 2P1. The upper slot 2P2 runs through the upper extending portion 24m. In the left-right direction, the dimension of the first portion 2P is greater than a dimension of the upper contact portion 223m. The upper slot 2P2 increases the elasticity of the first portion 2P such that the first portion 2P bends easily.

Referring to FIGS. 4, 5 and 6, an upper abutting portion 241m is formed at an end portion of the upper extending portion 24m away from the upper contact portion 223m. The upper abutting portion 241m is located on the second portion 2Q. In the left-right direction, the dimension of the first portion 2P is greater than a dimension of the upper abutting portion 241m.

Referring to FIGS. 4, 5 and 6, an upper supporting portion 25m is formed by bending and extending backward from an upper end of the supporting plate 2b. The upper supporting portion 25m has a horizontally extending portion. The upper supporting portion 25m is located below the upper contact portion 223m. When the first mating member 200 abuts downward against the upper contact portion 223m, the upper abutting portion 241m abuts against the horizontally extending portion of the upper supporting portion 25m. Compared with the case where only a single conductive path is provided passing through the upper contact portion 223m and the upper elastic portion 22m, the present invention further provides another conductive path passing through the upper contact portion 223m, the upper extending portion 24m and the upper supporting portion 25m, thereby reducing the impedance of the terminal 2 and achieving impedance matching.

Referring to FIG. 6, projections of the upper supporting portion 25m and the upper abutting portion 241m in the front-rear direction are both located within the upper through slot 23m. The upper supporting portion 25m is higher than a bottom portion of the upper through slot 23m, such that the upper through slot 23m provides clearance for the upper supporting portion 25m and the upper abutting portion 241m, avoiding interference between the upper abutting portion 241m and the upper elastic portion 22m. In the present embodiment, the upper supporting portion 25m and the upper abutting portion 241m are close to the upper through slot 23m but do not enter the upper through slot 23m. In other embodiments, the upper supporting portion 25m and the upper abutting portion 241m may enter the upper through slot 23m.

Referring to FIGS. 4 and 5, compared to the case where the upper supporting portion 25m is formed by bending an upper end of the supporting plate 2b and extending forward, forming the upper supporting portion 25m by bending the upper end of the supporting plate 2b and extending backward allows the terminal 2 to have a smaller dimension in the front-rear direction, thereby reducing the volume of the terminal 2, which is suitable for an electrical connector 100 with higher terminal density and higher-frequency performance.

Referring to FIG. 4, when the first mating member 200 abuts downward against the upper contact portion 223m to a final position, compared to an end of the upper supporting portion 25m connected to the supporting plate 2b, an abutting position of the upper abutting portion 241m and the upper supporting portion 25m is located closer to a tail end of the upper supporting portion 25m away from the supporting plate 2b. Compared to the case where the upper abutting portion 241m abuts against the upper supporting portion 25m at other positions, the upper elastic portion 22m and the upper extending portion 24m bend to a greater extent, and a height of the terminal 2 is smaller, thereby reducing the height of the electrical connector 100.

Referring to FIGS. 5 and 6, in the left-right direction, a dimension of the upper supporting portion 25m is greater than the dimension of the upper abutting portion 241m, and an abutting area of the upper abutting portion 241m and the upper supporting portion 25m is larger. When the upper abutting portion 241m deviates in the left-right direction, the upper abutting portion 241m still abuts against the upper supporting portion 25m, such that the contact between the upper supporting portion 25m and the upper abutting portion 241m is more stable.

Referring to FIGS. 4, 5 and 6, a lower elastic portion 22n is formed by bending from a lower end of the body portion 21 and then extending downward, and the lower elastic portion 22n firstly extends downward and backward and then extends downward and forward. The lower elastic portion 22n includes two lower branches 221n separated in the left-right direction and a lower shoulder portion 222n connecting bottom portions of the two lower branches 221n. A lower contact portion 223n is formed by extending from the lower shoulder portion 222n. A bottom portion of the lower elastic portion 22n is provided with the lower contact portion 223n, and the lower contact portion 223n is configured to downwardly abut against the second mating member 300. Each terminal 2 further includes a lower through slot 23n. The lower through slot 23n runs through the lower elastic portion 22n, and is located between the two lower branches 221n and the lower shoulder portion 222n. A lower extending portion 24n is formed by bending and extending upward from the lower contact portion 223n. A lower abutting portion 241n is formed at an end portion of the lower extending portion 24n away from the lower contact portion 223n. A lower supporting portion 25n is formed by extending backward from a lower end of the supporting plate 2b. The lower supporting portion 25n has a horizontally extending portion, and the lower supporting portion 25n is located above the lower contact portion 223n. When the second mating member 300 abuts upward against the lower contact portion 223n, the lower abutting portion 241n abuts against the lower supporting portion 25n.

Referring to FIGS. 4, 5 and 6, the lower contact portion 223n, the lower extending portion 24n, the lower abutting portion 241n and the lower supporting portion 25n are provided to be symmetrical with respect to the upper contact portion 223m, the upper extending portion 24m, the upper abutting portion 241m and the upper supporting portion 25m, respectively. In other embodiments, the lower contact portion 223n, the lower extending portion 24n, the lower abutting portion 241n and the lower supporting portion 25n may also be provided to be asymmetrical with respect to the upper contact portion 223m, the upper extending portion 24m, the upper abutting portion 241m and the upper supporting portion 25m.

Referring to FIG. 6, in the left-right direction, a dimension of the lower shoulder portion 222n is smaller than the dimension of the upper shoulder portion 222m. The dimension of the lower shoulder portion 222n is equal to a maximum dimension between the two lower branches 221n, thus facilitating insertion of the terminal 2 into the corresponding accommodating slot 11 downward from top.

Referring to FIGS. 4 and 5, the stopping block 111 extends into the corresponding lower through slot 23n. In other embodiments, the upper elastic portion 22m and the upper through slot 23m may also be provided to be symmetrical with the lower elastic portion 22n and the lower through slot 23n.

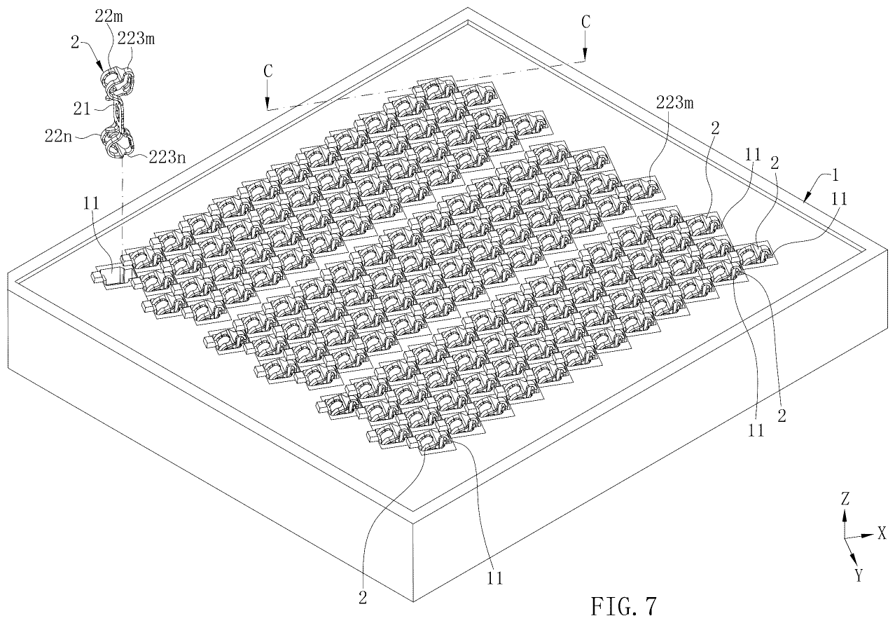

FIGS. 7 to 11 show an electrical connector 100 according to a second embodiment of the present invention. The electrical connector 100 includes a main body 1 and a plurality of terminals 2. The terminals 2 abut upwardly against a first mating member 200, and the first mating member 200 is a chip module. The terminals 2 abut downwardly against a second mating member 300, and the second mating member 300 is a circuit board. The main body 1 is made of an insulating material. In other embodiments, the first mating member 200 may be a circuit board and the second mating member 300 may be a chip module. It is also possible that the main body 1 may be partly made of an insulating material and partly made of a conductive material and/or a wave-absorbing material.

Referring to FIG. 7, the main body 1 includes a plurality of accommodating slots 11 running through the main body 1 along the vertical direction. Each terminal 2 is correspondingly accommodated in a corresponding one of the accommodating slots 11.

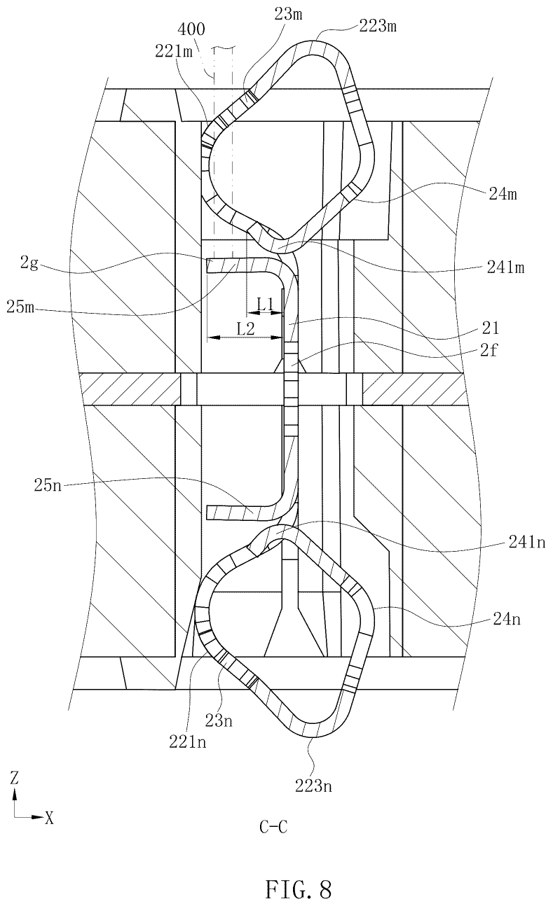

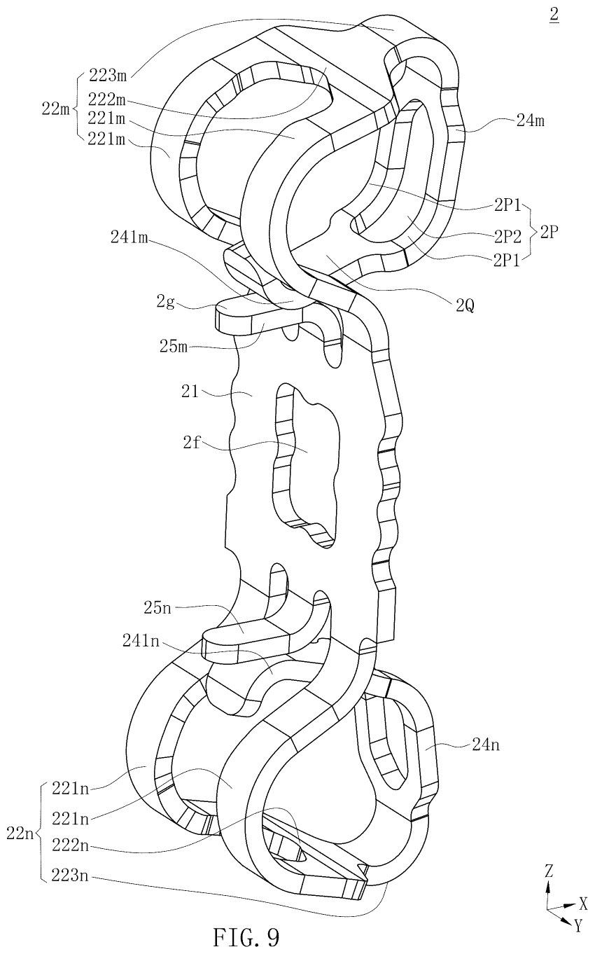

Referring to FIGS. 8 and 9, each terminal 2 includes a body portion 21. The body portion 21 matches with the corresponding accommodating slot 11 to fix the terminal 2 in the corresponding accommodating slot 11.

Referring to FIGS. 9, 10 and 11, each terminal 2 includes a through hole 2f. The through hole 2f runs through the body portion 21 in the front-rear direction.

Referring to FIGS. 8 and 9, an upper elastic portion 22m is formed by extending upward from an upper end of the body portion 21. A top portion of the upper elastic portion 22m has an upper contact portion 223m, and the upper contact portion 223m is configured to upwardly abut against the first mating member 200. In the front-rear direction, the upper contact portion 223m is located in front of the body portion 21.

Referring to FIG. 9, the upper elastic portion 22m firstly extends upward and backward from the upper end of the body portion 21 and then extends upward and forward. The upper elastic portion 22m includes two upper branches 221m separated in the left-right direction and an upper shoulder portion 222m connecting top ends of the two upper branches 221m. The upper contact portion 223m is formed by extending from the upper shoulder portion 222m.

Referring to FIG. 9, each terminal 2 includes an upper through slot 23m. The upper through slot 23m is located between the two upper branches 221m and the upper shoulder portion 222m. The upper through slot 23m increases the elasticity of the upper elastic portion 22m, and when the first mating member 200 abuts downward against the upper contact portion 223m, the upper elastic portion 22m bends more easily. The upper elastic portion 22m is provided with the two upper branches 221m, such that the upper elastic portion 22m forms two conductive paths, thus reducing the impedance of the upper elastic portion 22m, and thereby achieving impedance matching of the terminal 2.

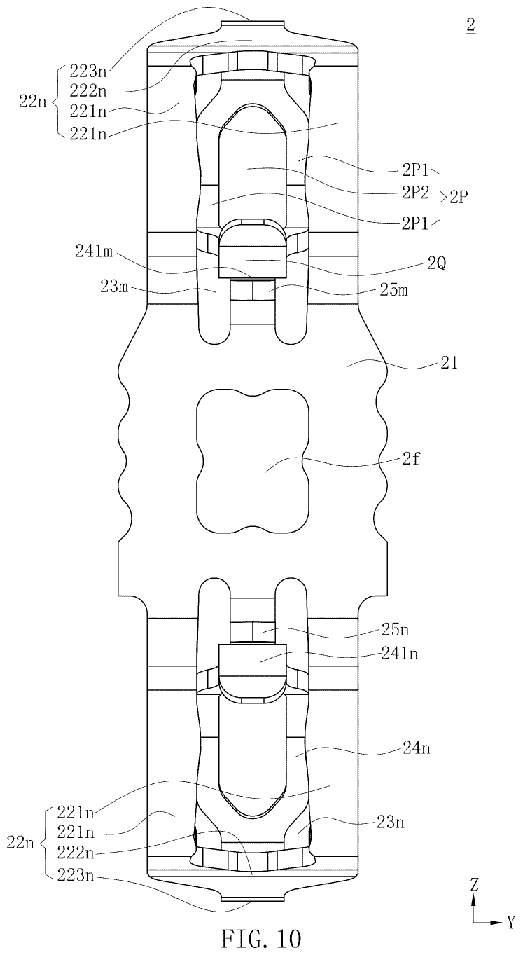

Referring to FIGS. 9 and 10, an upper extending portion 24m is formed by bending and extending downward from the upper contact portion 223m. The upper extending portion 24m includes a first portion 2P and a second portion 2Q. In the left-right direction, a dimension of the first portion 2P is greater than a dimension of the second portion 2Q. The first portion 2P includes two sub-portions 2P1 separated in the left-right direction and an upper slot 2P2 located between the two sub-portions 2P1. In the left-right direction, the dimension of the first portion 2P is greater than a dimension of the upper contact portion 223m. The upper slot 2P2 increases the elasticity of the first portion 2P such that the first portion 2P bends easily.

Referring to FIGS. 9 and 10, an upper abutting portion 241m is formed at an end portion of the upper extending portion 24m away from the upper contact portion 223m. The upper abutting portion 241m is located on the second portion 2Q. In the left-right direction, the dimension of the first portion 2P is greater than a dimension of the upper abutting portion 241m.

Referring to FIGS. 8 and 10, a projection of the upper abutting portion 241m in the front-rear direction is located in the upper through slot 23m, such that the upper through slot 23m provides clearance for the upper abutting portion 241m.

Referring to FIGS. 8 and 9, an upper supporting portion 25m is formed by extending backward from a bottom portion of the upper through slot 23m. The upper supporting portion 25m has a horizontally extending portion. The upper supporting portion 25m is located below the upper contact portion 223m. When the first mating member 200 abuts downward against the upper contact portion 223m, the upper abutting portion 241m passes through the upper through slot 23m and abuts against the upper supporting portion 25m.

Referring to FIGS. 8 and 9, compared with the case where only a single conductive path is provided passing through the upper contact portion 223m and the upper elastic portion 22m, the present invention further provides another conductive path passing through the upper contact portion 223m, the upper extending portion 24m and the upper supporting portion 25m, thereby reducing the impedance of the terminal 2 and achieving impedance matching.

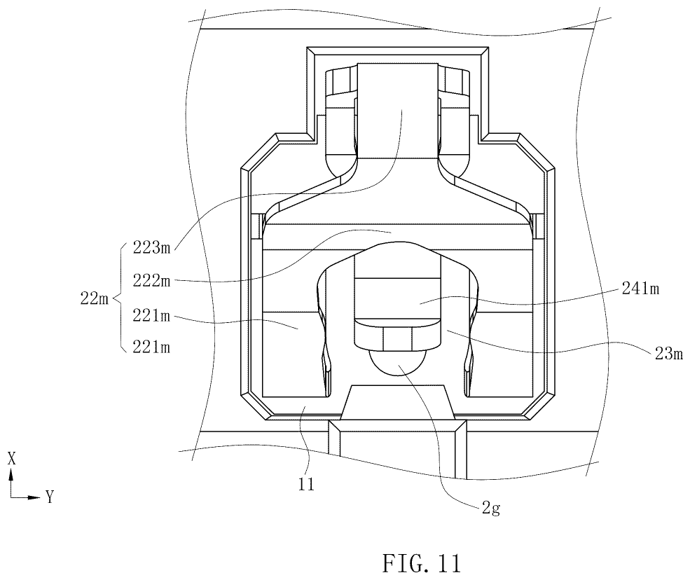

Referring to FIGS. 8 and 11, the upper supporting portion 25m is provided with a pushing portion 2g. The pushing portion 2g is provided to be lower than a top portion of the upper through slot 23m and higher than the bottom portion of the upper through slot 23m. The pushing portion 2g is exposed upward in the upper through slot 23m. In the front-rear direction, a distance L1 between a tail end of the upper supporting portion 25m and the body portion 21 is greater than a distance L2 between a tail end of the upper abutting portion 241m and the body portion 21. The pushing portion 2g is provided at an end of the upper supporting portion 25m away from the bottom portion of the upper through slot 23m, and the pushing portion 2g may be pushed by a jig 400 so as to adjust a position of the terminal 2 in the corresponding accommodating slot 11.

Referring to FIGS. 8 and 9, a lower elastic portion 22n is formed by bending from a lower end of the body portion 21 and then extending downward, and the lower elastic portion 22n firstly extends downward and backward and then extends downward and forward. The lower elastic portion 22n includes two lower branches 221n separated in the left-right direction and a lower shoulder portion 222n connecting bottom portions of the two lower branches 221n. A lower contact portion 223n is formed by extending from the lower shoulder portion 222n. The lower contact portion 223n is located at a bottom of the lower elastic portion 22n, and the lower contact portion 223n is configured to downwardly abut against the second mating member 300. Each terminal 2 includes a lower through slot 23n. The lower through slot 23n is located between the two lower branches 221n and the lower shoulder portion 222n. A lower extending portion 24n is formed by bending and extending upward from the lower contact portion 223n. A lower abutting portion 241n is formed at an end portion of the lower extending portion 24n away from the lower contact portion 223n. A lower supporting portion 25n is formed by extending backward from a top portion of the lower through slot 23n. The lower supporting portion 25n has a horizontally extending portion, and the lower supporting portion 25n is located above the lower contact portion 223n. When the second mating member 300 abuts upward against the lower contact portion 223n, the lower abutting portion 241n passes through the corresponding lower through slot 23n and abuts against the lower supporting portion 25n.

Referring to FIGS. 9 and 10, the lower elastic portion 22n, the lower contact portion 223n, the lower extending portion 24n, the lower abutting portion 241n, the lower through slot 23n and the lower supporting portion 25n are provided to be symmetrical with respect to the upper elastic portion 22m, the upper contact portion 223m, the upper extending portion 24m, the upper abutting portion 241m, the upper through slot 23m and the upper supporting portion 25m, respectively. In other embodiments, the lower elastic portion 22n, the lower contact portion 223n, the lower extending portion 24n, the lower abutting portion 241n, the lower through slot 23n and the lower supporting portion 25n may also be provided to be asymmetrical with respect to the upper elastic portion 22m, the upper contact portion 223m, the upper extending portion 24m, the upper abutting portion 241m, the upper through slot 23m and the upper supporting portion 25m.

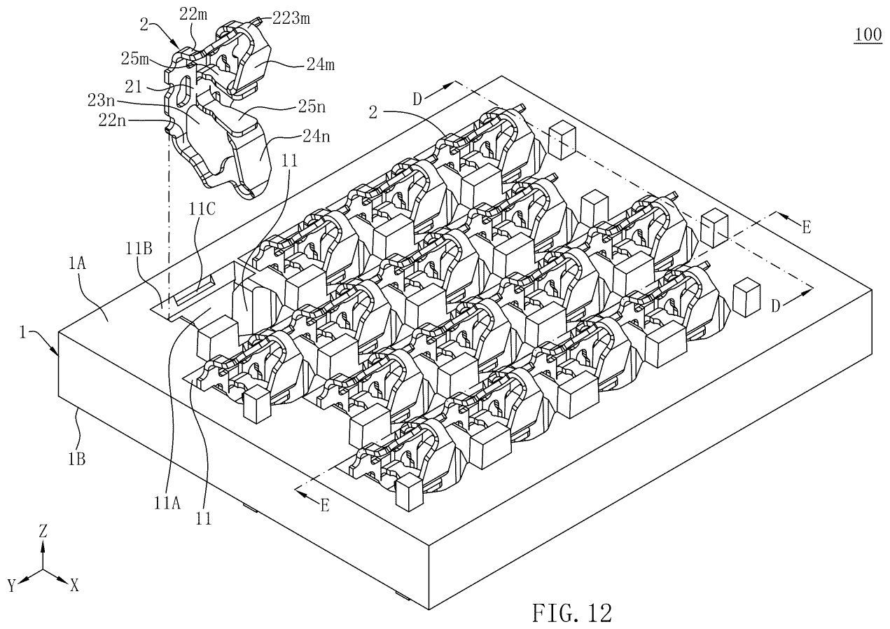

FIGS. 12 to 17 show an electrical connector 100 according to a third embodiment of the present invention. The electrical connector 100 includes a main body 1 and a plurality of terminals 2. The terminals 2 abut upwardly against a first mating member 200, and the first mating member 200 is a chip module. The terminals 2 abut downwardly against a second mating member 300, and the second mating member 300 is a circuit board. In other embodiments, the first mating member 200 may be a circuit board and the second mating member 300 may be a chip module.

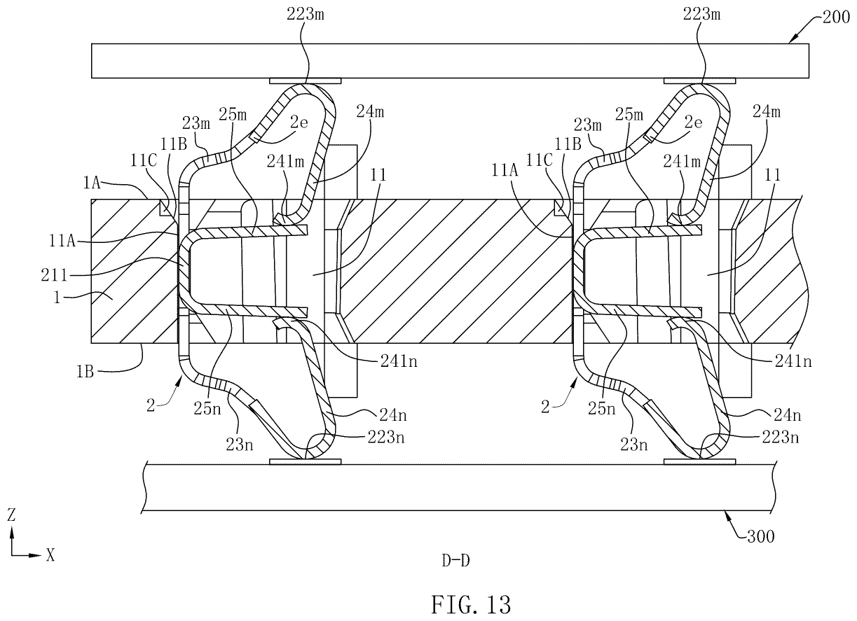

Referring to FIGS. 12 and 13, the main body 1 includes an upper surface 1A facing the first mating member 200, a lower surface 1B facing the second mating member 300 and a plurality of accommodating slots 11 running through the upper surface 1A and the lower surface 1B along the vertical direction. In the present embodiment, the main body 1 is insulating and is made of a plastic material. In other embodiments, the main body 1 may be made of other materials, or may be made of a combination of multiple materials, which may be entirely made of insulating materials, or may be partly made of an insulating material and partly made of a conductive material and/or a wave-absorbing material. The conductive material may be a metal material.

Referring to FIGS. 12 and 13, the terminals 2 are correspondingly accommodated in the accommodating slots 11. Each accommodating slot 11 includes a rear side wall 11A located behind the corresponding terminal 2 and a guiding inclined surface 11B extending from the upper surface 1A of the main body 1 to the rear side wall 11A. A reserved groove 11C is formed by recessing downward from the guiding inclined surface 11B.

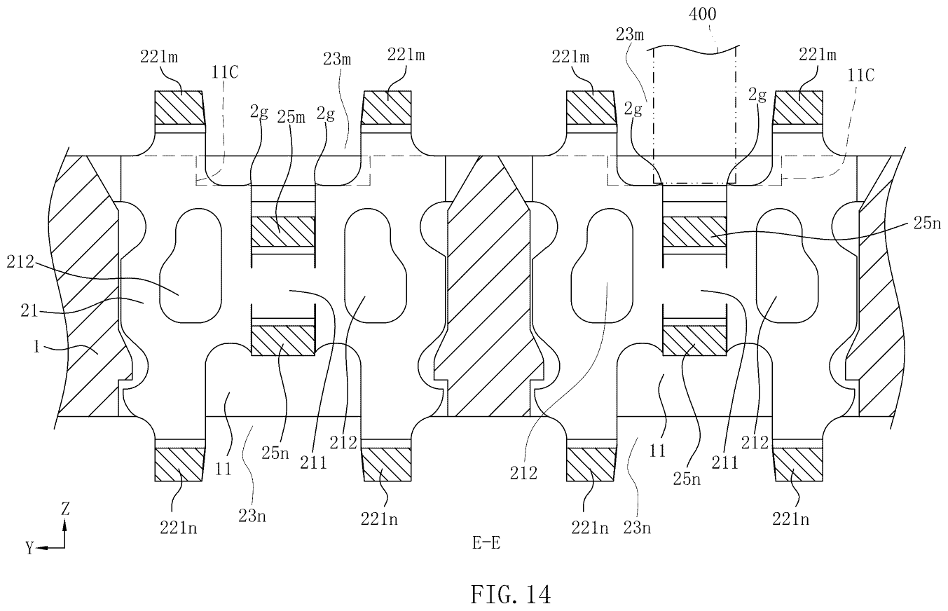

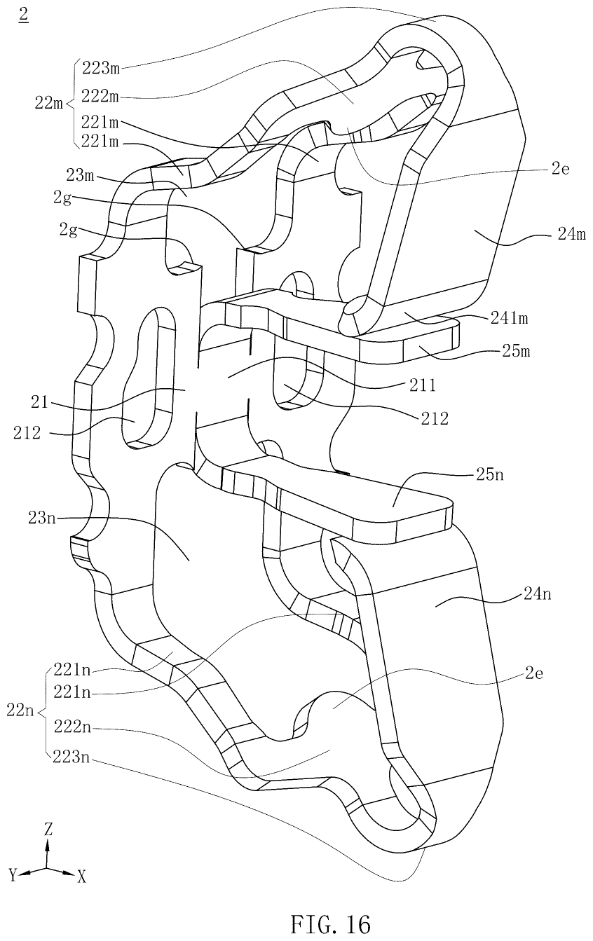

Referring to FIGS. 14 and 16, each terminal 2 includes a body portion 21 mounted in the corresponding accommodating slot 11. The body portion 21 is a flat-plate structure. The body portion 21 is provided with a connecting portion 211 and two slots 212 located on a left side and a right side of the connecting portion 211 and running through the body portion 21 in the front-rear direction. The connecting portion 211 is located between upper and lower boundaries of the slots 212 in the vertical direction.

Referring to FIGS. 13 and 16, an upper elastic portion 22m is formed by extending upward from an upper end of the body portion 21. A top portion of the upper elastic portion 22m has an upper contact portion 223m, and the upper contact portion 223m is located in front of the body portion 21. The upper contact portion 223m is configured to upwardly abut against the first mating member 200.

Referring to FIG. 16, the upper elastic portion 22m further includes two upper branches 221m separated in the left-right direction and an upper shoulder portion 222m connecting top ends of the two upper branches 221m. The upper contact portion 223m is formed by extending from the upper shoulder portion 222m. Compared to the case where the upper elastic portion 22m is provided with only one upper branch 221m, the upper elastic portion 22m in the present invention is provided with two upper branches 221m, thus increasing the conductive paths of the upper elastic portion 22m, such that the impedance of the upper elastic portion 22m is reduced, thereby achieving impedance matching of the terminal 2.

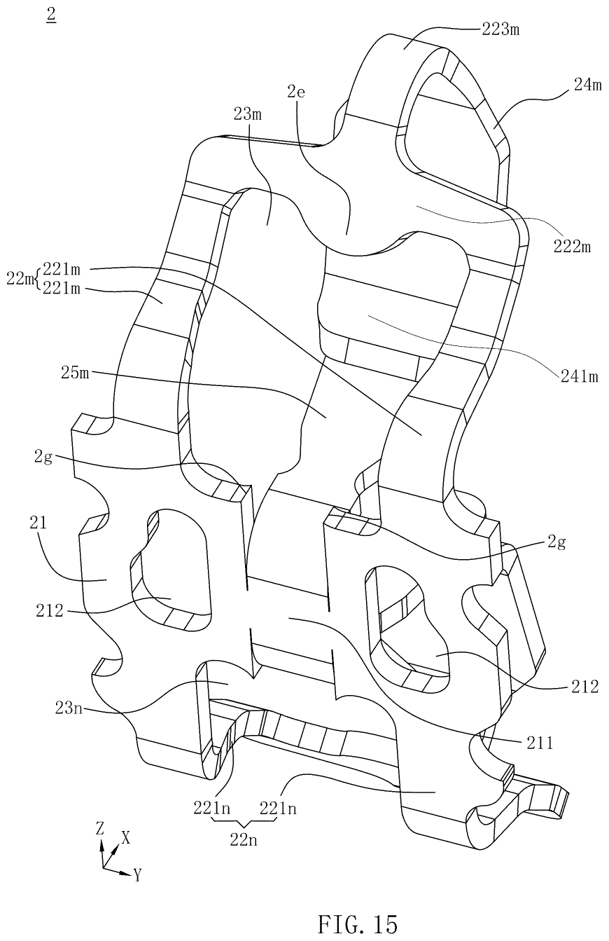

Referring to FIGS. 13 and 15, an upper through slot 23m is provided between the two upper branches 221m and the upper shoulder portion 222m. A bottom portion of the upper through slot 23m extends to the body portion 21. The upper through slot 23m increases the elasticity of the upper elastic portion 22m, and when the first mating member 200 abuts downward against the upper contact portion 223m, the upper elastic portion 22m bends more easily.

Referring to FIGS. 13 and 15, the upper shoulder portion 222m protrudes toward the upper through slot 23m to form a protruding portion 2e. The impedance magnitude is inversely proportional to a dimension of the upper shoulder portion 222m. The protruding portion 2e increases the dimension of the upper shoulder portion 222m in the vertical direction, thereby reducing the impedance of the upper shoulder portion 222m. Further, when the first mating member 200 abuts downward against the upper contact portion 223m, the upper shoulder portion 222m is close to the first mating member 200, such that the impedance near an abutting position of the upper contact portion 223m and the first mating member 200 is reduced, thereby achieving impedance matching of the terminal 2.

Referring to FIGS. 13 and 16, an upper extending portion 24m is formed by bending and extending downward from the upper contact portion 223m. An upper abutting portion 241m is formed at an end portion of the upper extending portion 24m away from the upper contact portion 223m.

Referring to FIGS. 13 and 16, an upper supporting portion 25m is formed by bending and extending forward from the bottom portion of the upper through slot 23m. The upper supporting portion 25m has a horizontally extending portion. The upper supporting portion 25m is located below the upper contact portion 223m. When the first mating member 200 abuts downward against the upper contact portion 223m, the upper abutting portion 241m abuts against the horizontally extending portion of the upper supporting portion 25m. The upper extending portion 24m may increase the conductive paths between the upper contact portion 223m and the body portion 21, thereby reducing the impedance of the terminal 2 and achieving impedance matching.

Referring to FIGS. 14 and 15, each terminal 2 includes two pushing portions 2g located on a left side and a right side of the upper through slot 23m. The pushing portions 2g are provided to be lower than a top portion of the upper through slot 23m and higher than the bottom portion of the upper through slot 23m. The two pushing portions 2g are located on the left side and the right side of the connecting portion 211. Viewing downward, the pushing portions 2g are exposed in the upper through slot 23m. In the process of each terminal 2 being mounted into the corresponding accommodating slot 11, a jig 400 may extend into the upper through slot 23m to push the pushing portions 2g, thereby mounting the terminal 2 into the corresponding accommodating slot 11.

Referring to FIGS. 14 and 16, a highest point of each pushing portion 2g is higher than the upper supporting portion 25m, so as to prevent the jig 400 from pushing the upper supporting portion 25m and causing bending and deformation of the upper supporting portion 25m.

Referring to FIGS. 13 and 14, since the two pushing portions 2g are located at the left side and the right side of the connecting portion 211, in the front-rear direction, compared with an end of the upper supporting portion 25m connected to the connecting portion 211, an abutting position of the upper abutting portion 241m and the upper supporting portion 25m is closer to an end of the upper supporting portion 25m away from the connecting portion 211, such that the upper abutting portion 241m is further away from the pushing portions 2g, preventing the jig 400 from pushing the upper abutting portion 241m and causing deformation of the upper abutting portion 241m.

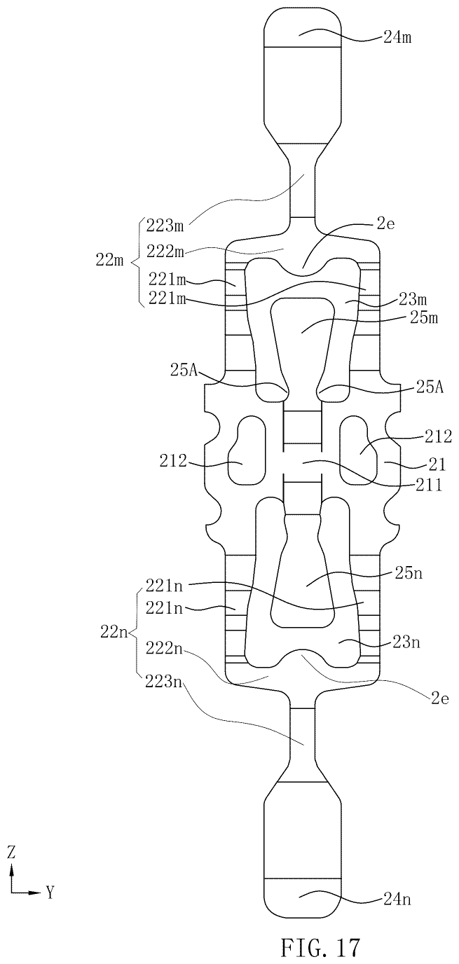

Referring to FIGS. 15 and 17, the pushing portions 2g are sharp-angle shaped, and the upper supporting portion 25m is provided with two notches 25A, where the two notches 25A are respectively recessed at left and right sides of the upper supporting portion 25m. Before the terminal 2 is formed, each of the notches 25A is respectively connected to a corresponding one of the two pushing portions. 2g. The notches 25A and the pushing portions 2g are formed by cutting by a same mold, and cutting edges of the mold correspond to the shapes of the pushing portions 2g and the notches 25A. If the notches 25A are not provided, the mold would need to have sharp corners corresponding to the pushing portions 2g, thus making the mold difficult to manufacture. Providing the notches 25A prevents the mold from having the sharp corners, thus facilitating manufacture of the mold, and the mold is not easily damaged.

Referring to FIGS. 13 and 14, a highest point of each pushing portion 2g is flush with or higher than a bottom surface of the reserved groove 11C. When the jig 400 pushes the pushing portions 2g, the guiding inclined surface 11B guides the corresponding terminal 2, thus facilitating assembly of the terminal 2 into the corresponding accommodating slot 11. The reserved groove 11C may provide clearance for the jig 400. A bottom surface of the reserved groove 11C may serve as a reference surface for mounting the terminal 2, preventing the jig 400 from continuously pushing the terminal 2 downward after the terminal 2 is in its final position.

Referring to FIGS. 13 and 16, a lower elastic portion 22n is formed by extending downward from the body portion 21. A bottom portion of the lower elastic portion 22n has a lower contact portion 223n. The lower contact portion 223n is located in front of the body portion 21, and the lower contact portion 223n is configured to downwardly abut against the second mating member 300. The lower elastic portion 22n further includes two lower branches 221n separated in the left-right direction and a lower shoulder portion 222n connecting bottom ends of the two lower branches 221n. The lower contact portion 223n is formed by extending from the lower shoulder portion 222n.

Referring to FIG. 14, a lower through slot 23n is provided between the two lower branches 221n and the lower shoulder portion 222n. A top portion of the lower through slot 23n extends to the body portion 21.

Referring to FIGS. 14 and 16, the upper through slot 23m and the lower through slot 23n respectively extend to the body portion 21, thus more effectively increasing the elasticity of the upper elastic portion 22m and the lower elastic portion 22n, allowing the upper elastic portion 22m and the lower elastic portion 22n to bend more easily.

Referring to FIGS. 16 and 17, a protruding portion 2e is also formed by extending upward from a bottom portion of the lower through slot 23n. After the lower elastic portion 22n abuts against the second mating member 300, the protruding portion 2e corresponding to the lower through slot 23n is close to an abutting position of the lower elastic portion 22n and the second mating member 300. The protruding portion 2e reduces the inductance near the abutting position of the lower elastic portion 22n and the second mating member 300, such that the impedance at the abutting position of the lower elastic portion 22n and the second mating member 300 is reduced, and thereby achieving impedance matching of the terminal 2.

Referring to FIGS. 13 and 16, a lower extending portion 24n is formed by bending and extending upward from the lower contact portion 223n. A lower abutting portion 241n is formed at an end portion of the lower extending portion 24n away from the lower contact portion 223n.

Referring to FIGS. 13 and 16, in the front-rear direction, the upper abutting portion 241m is located closer to the body portion 21 relative to the upper contact portion 223m, and the lower abutting portion 241n is located closer to the body portion 21 relative to the lower contact portion 223n.

Referring to FIGS. 16 and 17, in the left-right direction, a dimension of the upper abutting portion 241m is greater than a dimension of the upper contact portion 223m, and a dimension of the lower abutting portion 241n is greater than a dimension of the lower contact portion 223n.

Referring to FIGS. 13 and 16, a lower supporting portion 25n is formed by bending and extending forward from a top portion of the lower through slot 23n. The lower supporting portion 25n has a horizontally extending portion. When the second mating member 300 abuts upward against the lower contact portion 223n, the lower abutting portion 241n abuts against the horizontally extending portion of the lower supporting portion 25n.

Referring to FIGS. 13, 16 and 17, the connecting portion 211 is a continuous plate-shaped structure. That is, the connecting portion 211 is not provided with any slot running therethrough in the front-rear direction. An upper end of the connecting portion 211 is connected to the upper supporting portion 25m, and a lower end of the connecting portion 211 is connected to the lower supporting portion 25n. The upper supporting portion 25m and the lower supporting portion 25n are provided to be vertically aligned.

Referring to FIGS. 16 and 17, in the left-right direction, a dimension of the upper supporting portion 25m at an end connected to the connecting portion 211 is smaller than a dimension of the upper supporting portion 25m at an end away from the connecting portion 211, and a dimension of the lower supporting portion 25n at an end connected to the connecting portion 211 is smaller than a dimension of the lower supporting portion 25n at an end away from the connecting portion 211. Since the body portion 21 is provided with the two slots 212 at the left side and the right side of the body portion 21, and the metal plate corresponding to the position of the upper through slot 23m forms the upper supporting portion 25m as well as the metal plates adjacent to the left side and the right side of the upper through slot 23m form the two pushing portions 2g located at the left side and the right side of the upper supporting portion 25m, the dimension of the end of the upper supporting portion 25m connected to the connecting portion 211 is smaller than the dimension of the end of the upper supporting portion 25m away from the connecting portion 211. Meanwhile, as the dimension of the end of the upper supporting portion 25m away from the connecting portion 211 is larger, the contact between the upper abutting portion 241m and the upper supporting portion 25m is more stable, and the impedance at the end of the upper supporting portion 25m away from the connecting portion 211 may be reduced, thus enabling the impedance matching of the terminal 2. The dimension of the end of the lower supporting portion 25n connected to the connecting portion 211 is smaller than the dimension of the end of the lower supporting portion 25n away from the connecting portion 211, and the dimension of the end of the lower supporting portion 25n away from the connecting portion 211 is larger.

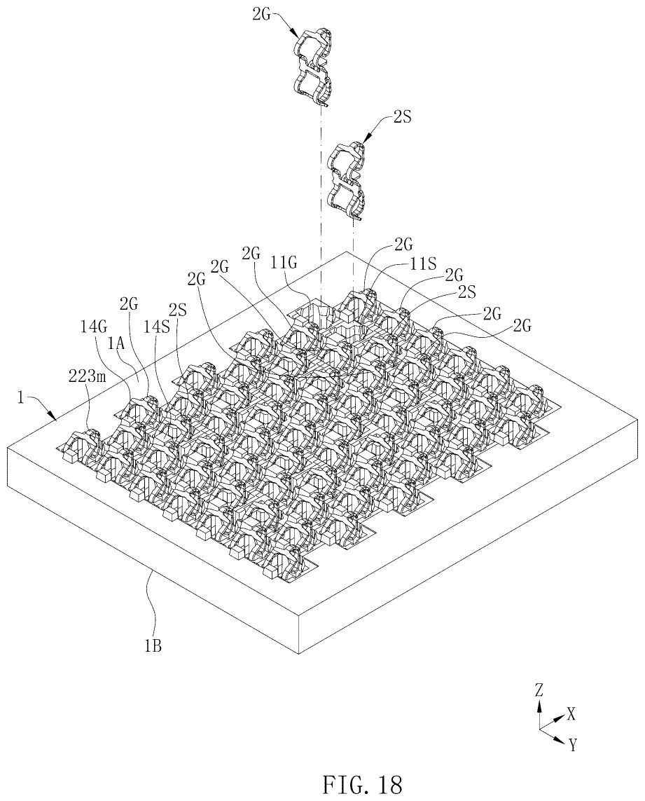

FIGS. 18 to 24 show an electrical connector 100 according to a fourth embodiment of the present invention. The electrical connector 100 includes a main body 1 and a plurality of terminals 2. The main body 1 is insulating and is made of a plastic material. In other embodiments, the main body 1 may be made of other materials, or may be made of a combination of multiple materials, which may be entirely made of insulating materials, or may be partly made of an insulating material and partly made of a conductive material and/or a wave-absorbing material. The terminals 2 are made of a metal material. The terminals 2 abut upwardly against a first mating member 200, and the first mating member 200 is a chip module. The terminals 2 abut downwardly against a second mating member 300, and the second mating member 300 is a circuit board. In other embodiments, the first mating member 200 may be a circuit board and the second mating member 300 may be a chip module.

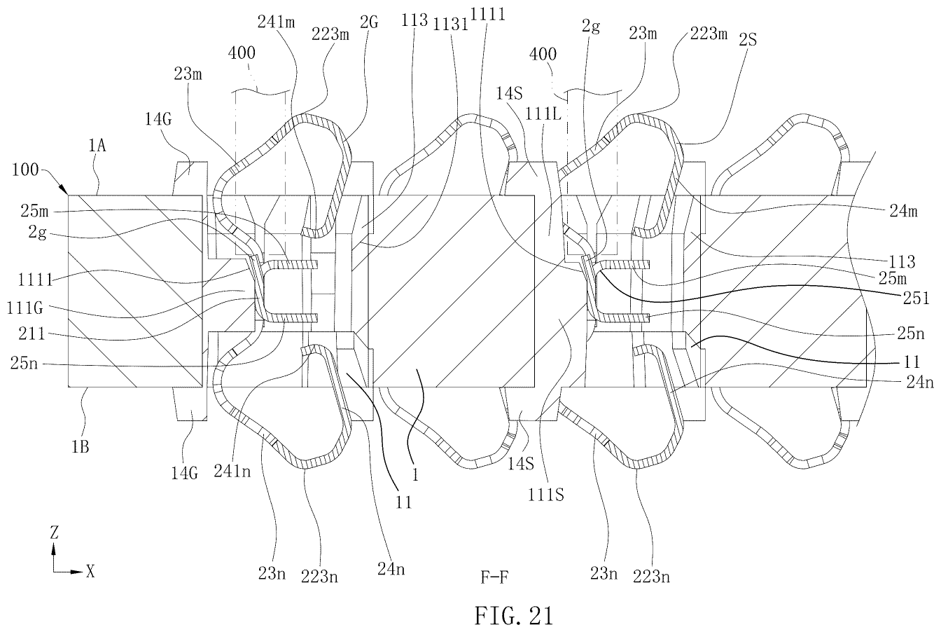

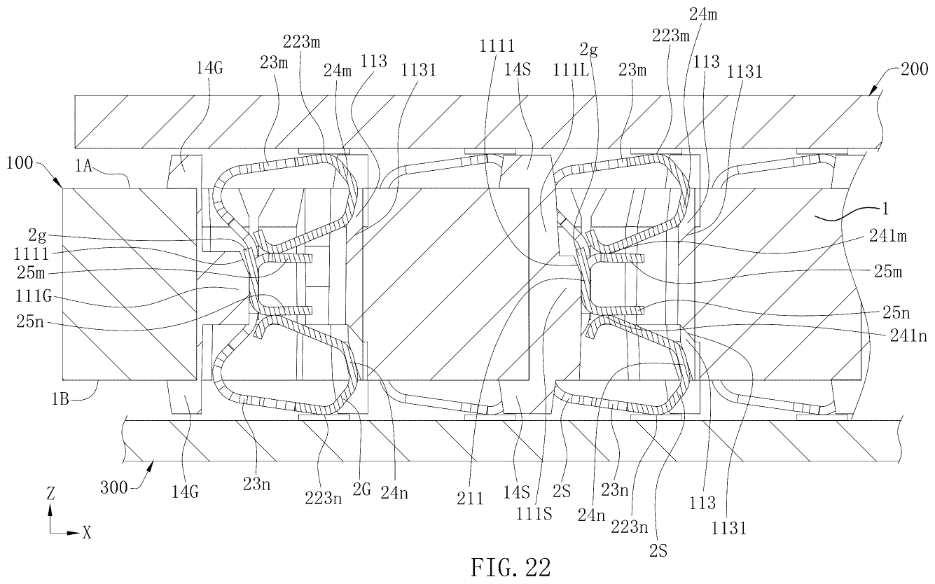

Referring to FIGS. 21 and 22, the main body 1 includes an upper surface 1A facing the first mating member 200, a lower surface 1B facing the second mating member 300 and a plurality of accommodating slots 11 running through the upper surface 1A and the lower surface 1B along the vertical direction. The terminals 2 are correspondingly accommodated in the accommodating slots 11.

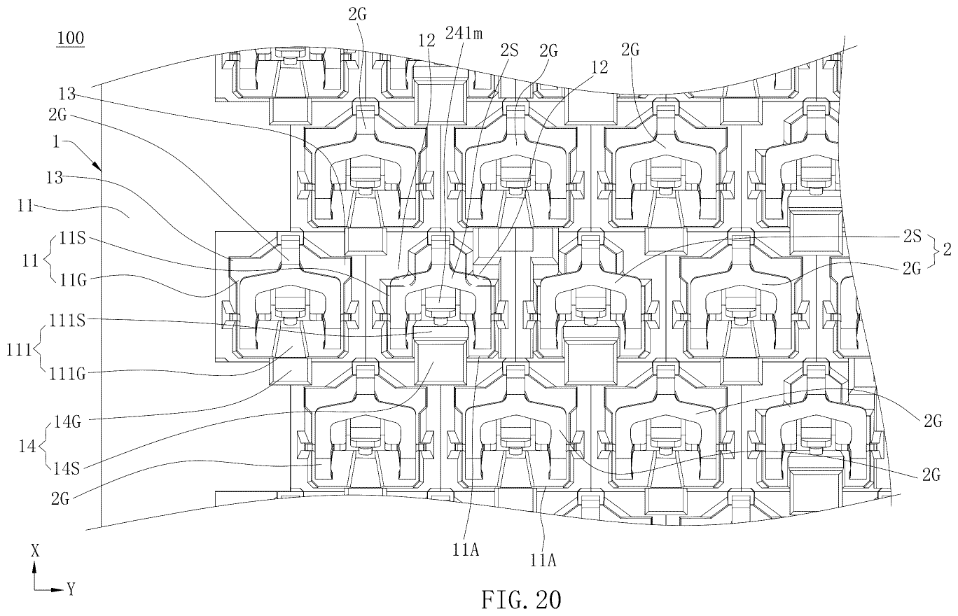

Referring to FIGS. 20 and 21, the accommodating slots 11 include a plurality of signal accommodating slots 11S and a plurality of ground accommodating slots 11G. Each accommodating slot 11 includes a rear side wall 11A located behind the corresponding terminal 2. The main body 1 is provided with a stopping block 111 in each accommodating slot 11, protruding forward from the rear side wall 11A thereof. The stopping blocks 111 include a plurality of signal stopping blocks 111S located in the signal accommodating slots 11S and a plurality of ground stopping blocks 111G located in the ground accommodating slots 11G. Each stopping block 111 has a guiding surface 1111 which is inclined.

Referring to FIGS. 20 and 21, the upper surface 1A and the lower surface 1B are respectively provided with a plurality of signal supporting blocks 14S corresponding to the signal accommodating slots 11S and a plurality of ground supporting blocks 14G corresponding to the ground accommodating slots 11G.

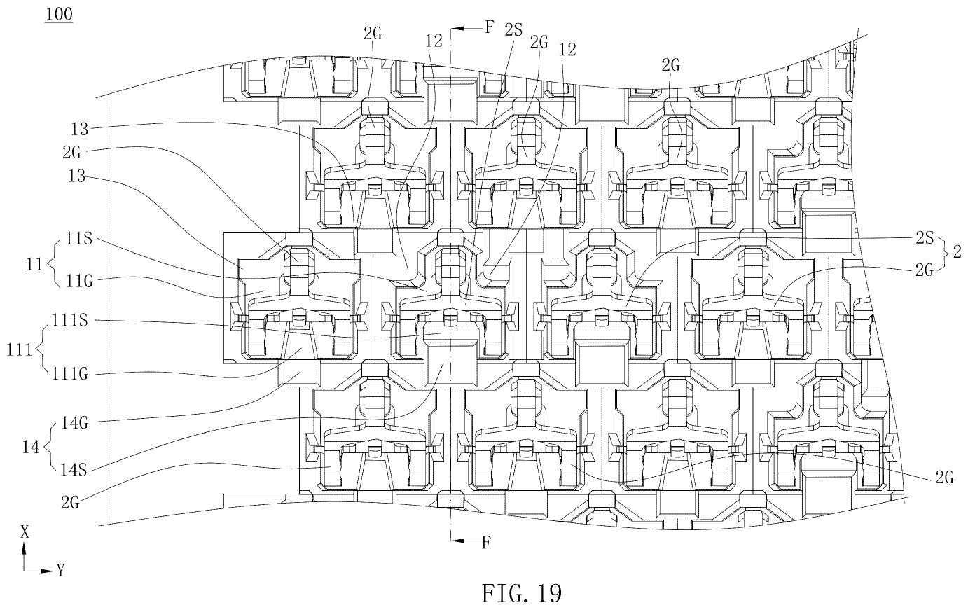

Referring to FIGS. 19 and 21, in the left-right direction, a dimension of each signal stopping block 111S is greater than a dimension of each ground stopping block 111G. A bottom portion of each signal stopping block 111S extends downward to be flush with the lower surface 1B, and is connected to the corresponding signal supporting block 14S provided on the lower surface 1B. The main body 1 further includes a connecting block 111L in each signal accommodating slot 11S, protruding forward from the rear side wall 11A thereof. In the front-rear direction, a dimension of each connecting block 111L is smaller than a dimension of each signal stopping block 111S. Each connecting block 111L connects the corresponding signal stopping block 111S to the corresponding signal supporting block 14S on the upper surface 1A.

Referring to FIGS. 19 and 21, a top portion of each ground stopping block 111G is lower than the upper surface 1A, and a bottom portion of each ground stopping block 111G is higher than the lower surface 1B. A volume of each signal stopping block 111S is greater than a volume of each ground stopping block 111G.

Referring to FIGS. 19 and 21, in both the left-right direction and the front-rear directions, a dimension of each signal supporting block 14S is greater than a dimension of each ground supporting block 14G. In the vertical direction, a dimension of each signal supporting block 14S and a dimension of the ground supporting block 14G are equal. That is, a volume of each signal supporting block 14S is greater than a volume of each ground supporting block 14G.

Referring to FIGS. 19 and 20, in each signal accommodating slot 11S, front ends of a left side wall and a right side wall protrude inward toward the corresponding signal accommodating slot 11S to form two protruding blocks 12. In each ground accommodating slot 11G, front ends of a left side wall and a right side wall are recessed outward away from the corresponding ground accommodating slot 11G to form two recesses 13.

Referring to FIGS. 18 and 19, the terminals 2 include a plurality of signal terminals 2S and a plurality of ground terminals 2G. The signal terminals 2S and the ground terminals 2G have identical shapes. The signal terminals 2S are accommodated in the signal accommodating slots 11S, and the ground terminals 2G are accommodated in the ground accommodating slots 11G. In the left-right direction, each ground terminal 2G is located between two adjacent signal terminals 2S.

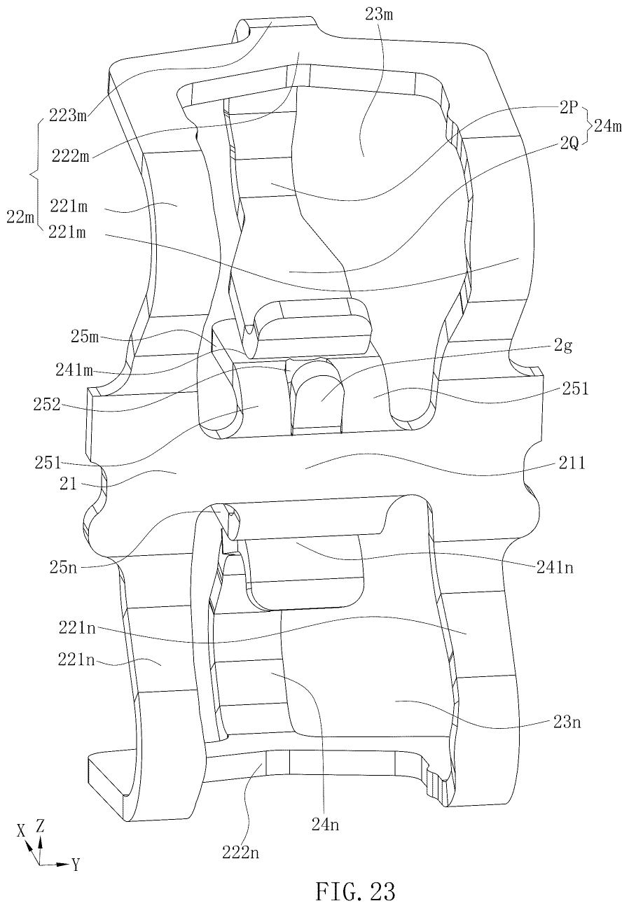

Referring to FIGS. 22 and 23, each terminal 2 includes a body portion 21 fixed and retained in the corresponding accommodating slot 11. The body portion 21 is a flat-plate structure, and the body portion 21 is provided with a connecting portion 211. The stopping block 111 abuts against a rear side of the body portion 21.

Referring to FIGS. 22 and 23, an upper elastic portion 22m is formed by firstly bending and extending upward and backward from an upper end of the body portion 21 and then extending upward and forward. The stopping block 111 is provided in the corresponding accommodating slot 11 to abut against the body portion 21, and when at least a portion of the upper elastic portion 22m is located above the stopping block 111, the stopping block 111 may prevents the body portion 21 from moving in the front-rear direction in the process of the first mating member 200 pressing the terminal 2 downward. A top portion of the upper elastic portion 22m has an upper contact portion 223m configured to upwardly abut against the first mating member 200. The upper contact portion 223m is located in front of the body portion 21.

Referring to FIGS. 20 and 22, when the first mating member 200 presses the terminal 2 downward to a final position, viewing downward from top, each protruding block 12 partially overlaps with the upper elastic portion 22m.

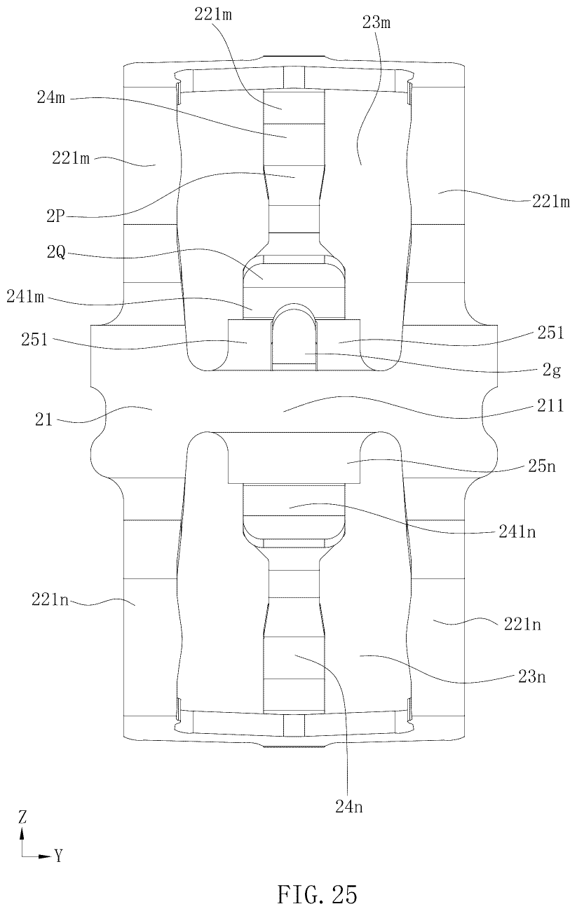

Referring to FIGS. 23 and 25, the upper elastic portion 22m further includes two upper branches 221m separated in the left-right direction and an upper shoulder portion 222m connecting top ends of the two upper branches 221m. The upper contact portion 223m is formed by extending from the upper shoulder portion 222m. Compared to the case where the upper elastic portion 22m is provided with only one upper branch 221m, the upper elastic portion 22m in the present invention is provided with two upper branches 221m, such that the upper elastic portion 22m forms two conductive paths, thus reducing the impedance of the upper elastic portion 22m, and thereby achieving impedance matching of the terminal 2.

Referring to FIGS. 22 and 23, an upper through slot 23m is provided between the two upper branches 221m and the upper shoulder portion 222m. A bottom portion of the upper through slot 23m extends to the body portion 21. The upper through slot 23m increases the elasticity of the upper elastic portion 22m, and when the first mating member 200 abuts downward against the upper contact portion 223m, the upper elastic portion 22m bends more easily.

Referring to FIGS. 21 and 23, an upper extending portion 24m is formed by firstly extending downward and forward from the upper contact portion 223m and then extending downward and backward. An upper abutting portion 241m is formed at an end portion of the upper extending portion 24m away from the upper contact portion 223m. The upper extending portion 24m includes a first portion 2P and a second portion 2Q. The first portion 2P connects the upper contact portion 223m and the second portion 2Q. The second portion 2Q is provided with the upper abutting portion 241m.

Referring to FIGS. 21 and 22, a reserved groove 113 is provided in each accommodating slot 11 at a position corresponding to the upper extending portion 24m. A bottom portion of the reserved groove 113 is an inclined surface 1131 extending downward and backward from a front side wall of the reserved groove 113. When the first mating member 200 presses the upper contact portion 223m downward, the reserved groove 113 and the inclined surface 1131 both provide clearance for the upper extending portion 24m. An inclined direction of the inclined surface 1131 is consistent with a bending direction of the upper extending portion 24m, thus providing better clearance for the upper extending portion 24m.

Referring to FIGS. 22 and 23, an upper supporting portion 25m is formed by bending and extending forward from a bottom portion of the upper through slot 23m. The upper supporting portion 25m includes two bending portions 251 formed by bending and extending from the bottom portion of the upper through slot 23m, and a horizontal portion linearly extending forward from the two bending portions 251. The horizontal portion occupies most of the upper supporting portion 25m. When the first mating member 200 abuts downward against the upper contact portion 223m, the upper abutting portion 241m abuts against the upper supporting portion 25m. The upper extending portion 24m increases the conductive paths between the upper contact portion 223m and the body portion 21.

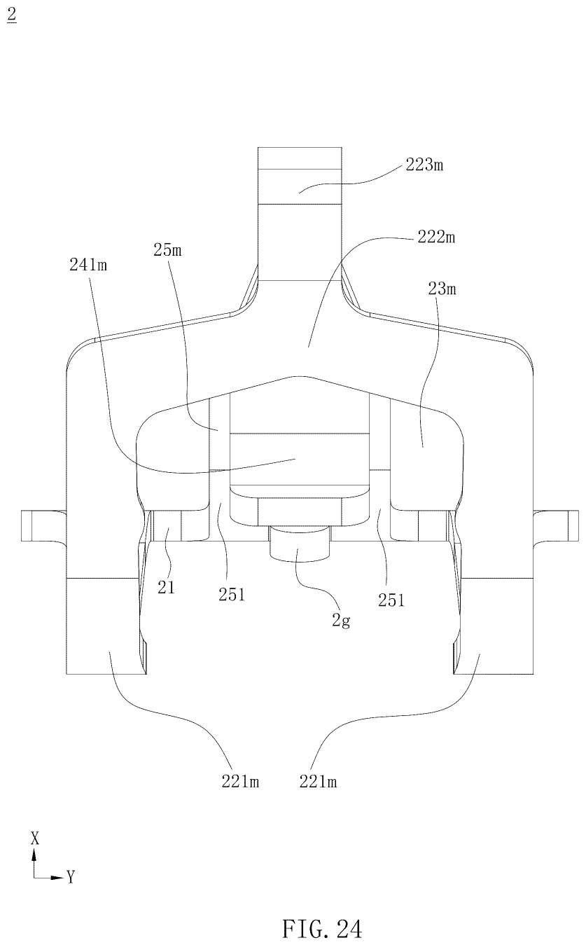

Referring to FIGS. 23 and 24, in the left-right direction, a dimension of the upper supporting portion 25m is greater than a dimension of the upper abutting portion 241m, and an abutting area of the upper abutting portion 241m and the upper supporting portion 25m is larger. When the upper abutting portion 241m deviates in the left-right direction, the upper abutting portion 241m still abuts against the upper supporting portion 25m, such that the contact between the upper supporting portion 25m and the upper abutting portion 241m is more stable.

Referring to FIGS. 24 and 25, in the left-right direction, a dimension of the upper through slot 23m is greater than a dimension of the upper supporting portion 25m. Thus, when the dimension of the upper supporting portion 25m is greater than the dimension of the upper abutting portion 241m, a dimension of the upper through slot 23m is also greater than the dimension of the upper abutting portion 241m. A projection of the upper abutting portion 241m in the front-rear direction is located within the upper through slot 23m. The upper extending portion 24m is formed by firstly extending downward and forward from the upper contact portion 223m and then extending downward and backward, and when the first mating member 200 abuts downward against the upper contact portion 223m to a final position, interference between the upper abutting portion 241m and the upper elastic portion 22m may be prevented.

Referring to FIGS. 22 and 23, in the left-right direction, a dimension of the second portion 2Q is greater than a dimension of the first portion 2P, and the upper abutting portion 241m is provided on the second portion 2Q, thus reducing the inductance near the upper abutting portion 241m and thereby reduces impedance. In addition, the elasticity of the first portion 2P is greater than that of the second portion 2Q. When the first mating member 200 presses the upper contact portion 223m downward, the first portion 2P bends more easily, thus facilitating bending of the upper extending portion 24m for the upper abutting portion 241m to contact the upper supporting portion 25m. Further, the upper abutting portion 241m is provided on the second portion 2Q. Thus, in the left-right direction, the dimension of the upper abutting portion 241m is also greater than the dimension of the first portion 2P, thereby increasing the contact area between the upper abutting portion 241m and the upper supporting portion 25m, such that the contact between the upper abutting portion 241m and the upper supporting portion 25m is more stable.

Referring to FIGS. 21, 23 and 24, the two bending portions 251 are provided at an interval in the left-right direction to form an opening 252, such that a space exists between the two bending portions 251 to form a pushing portion 2g therein. The pushing portion 2g is formed by extending upward from a bottom portion of the opening 252. That is, the pushing portion 2g is formed by cutting a portion of the metal material of the terminal 2 to form the opening 252. The pushing portion 2g is provided to be lower than a top portion of the upper through slot 23m and higher than a bottom portion of the upper through slot 23m. Viewing downward, the pushing portion 2g is exposed in the upper through slot 23m. In the mounting process of the terminal 2 into the corresponding accommodating slot 11, a jig 400 may extend into the upper through slot 23m to push the pushing portion 2g, thereby mounting the terminal 2 into the corresponding accommodating slot 11.

Referring to FIGS. 21 and 23, a highest point of the pushing portion 2g is higher than the upper supporting portion 25m, thus preventing the jig 400 from pushing the upper supporting portion 25m and causing bending of the upper supporting portion 25m.

Referring to FIGS. 22 and 23, when the first mating member 200 presses the upper contact portion 223m downward, the upper elastic portion 22m and the upper extending portion 24m bend, and the upper abutting portion 241m moves backward. The pushing portion 2g extends backward obliquely from the bottom portion of the opening 252. That is, the pushing portion 2g extends obliquely toward a direction away from the upper abutting portion 241m, thus preventing interference between the upper abutting portion 241m and the pushing portion 2g.

Referring to FIGS. 23 and 24, in the left-right direction, the dimension of the upper abutting portion 241m is greater than a dimension of the opening 252. When the first mating member 200 abuts against the upper contact portion 223m to the final position, the upper abutting portion 241m abuts against a front end of the opening 252, preventing the upper abutting portion 241m from moving backward and entering the opening 252 after bending of the upper extending portion 24m.

Referring to FIG. 21, a top portion of the pushing portion 2g is higher than a top portions of the stopping blocks 111S/111G (and in other embodiments, the top portion of the pushing portion 2g may be flush with the top portions of the stopping blocks 111S/111G), thus providing clearance for the jig 400 and the terminal 2, facilitating mounting of the terminal 2 into the corresponding accommodating slot 11 downward from top. If the top portion of the pushing portion 2g were lower than the top portions of the stopping blocks 111S/111G, the jig 400 cannot pass backward beyond the stopping blocks 111S/111G, and the jig 400 cannot pass forward beyond the upper extending portion 24m. In this case, the jig 400 has a relatively small dimension in the front-rear direction and thus would be difficult to manufacture. In the present invention, the top portion of the pushing portion 2g is higher than or flush with the top portions of the stopping blocks 111S/111G, thus providing clearance for the jig 400, and the jig 400 may be designed to have a greater dimension in the front-rear direction and is thus easier to manufacture.

Referring to FIG. 21, the guiding surface 1111 of each stopping block 111S/111G is provided at a position corresponding to the pushing portion 2g, and an inclined direction of the guiding surface 1111 is consistent with an inclined direction of the pushing portion 2g. The guiding surface 1111 provides clearance for the pushing portion 2g, and when the terminal 2 is mounted into the corresponding accommodating slot 11 downward from top, the guiding surface 1111 may guide the terminal 2, thereby facilitating assembly of the terminal 2 into the corresponding accommodating slot 11.

Referring to FIGS. 22 and 23, a lower elastic portion 22n is formed by firstly bending and extending downward and backward from a lower end of the body portion 21 and then extending downward and forward. A bottom portion of the lower elastic portion 22n has a lower contact portion 223n configured to downwardly abut against the second mating member 300. The lower elastic portion 22n further includes two lower branches 221n separated in the left-right direction and a lower shoulder portion 222n connecting bottom ends of the two lower branches 221n. The lower contact portion 223n is formed by extending from the lower shoulder portion 222n. A lower through slot 23n is provided between the two lower branches 221n. A top portion of the lower through slot 23n extends to the body portion 21.

Referring to FIGS. 22 and 23, the upper through slot 23m and the lower through slot 23n respectively extend to the body portion 21, thus more effectively increasing the elasticity of the upper elastic portion 22m and the lower elastic portion 22n, allowing the upper elastic portion 22m and the lower elastic portion 22n to bend more easily.

Referring to FIGS. 20 and 21, each connecting block 111L is partially located between the two upper branches 221m of each signal terminal 2S. Each signal stopping block 111S is partially located between the two lower branches 221n of each signal terminal 2S. Each ground stopping block 111G is located below the two upper branches 221m of the corresponding ground terminal 2G and above the two lower branches 221n of the corresponding ground terminal 2G. That is, each ground stopping block 111G does not have any portion located between the two upper branches 221m of the corresponding ground terminal 2G or between the two lower branches 221n of the corresponding ground terminal 2G.

Referring to FIGS. 20 and 21, each signal supporting block 14S is partially located between the two lower branches 221n of the corresponding signal terminal 2S. Each ground supporting block 14G is located behind the corresponding ground accommodating slot 11G. That is, each ground supporting block 14G does not have any portion located between the two upper branches 221m of the corresponding ground terminal 2G or between the two lower branches 221n of the corresponding ground terminal 2G.

Referring to FIGS. 22 and 23, a lower extending portion 24n is formed by firstly extending upward and forward from the lower contact portion 223n and then extending upward and backward. A lower abutting portion 241n is formed at an end portion of the lower extending portion 24n away from the lower contact portion 223n.

Referring to FIGS. 23 and 24, in the left-right direction, the dimension of the upper abutting portion 241m is greater than a dimension of the upper contact portion 223m, and a dimension of the lower abutting portion 241n is greater than a dimension of the lower contact portion 223n.

Referring to FIGS. 21 and 25, the lower elastic portion 22n, the lower contact portion 223n, the lower extending portion 24n, the lower abutting portion 241n and the lower through slot 23n are provided to be symmetrical with respect to the upper elastic portion 22m, the upper contact portion 223m, the upper extending portion 24m, the upper abutting portion 241m and the upper through slot 23m, respectively. In other embodiments, the lower elastic portion 22n, the lower contact portion 223n, the lower extending portion 24n, the lower abutting portion 241n and the lower through slot 23n are also provided to be asymmetrical with respect to the upper elastic portion 22m, the upper contact portion 223m, the upper extending portion 24m, the upper abutting portion 241m and the upper through slot 23m.

Referring to FIG. 22, a reserved groove 113 and an inclined surface 1131 are also provided in each accommodating slot 11 at a position corresponding to the lower extending portion 24n. The reserved groove 113 and the inclined surface 1131 corresponding to the lower extending portion 24n are provided to be symmetrical with the reserved groove 113 and the inclined surface 1131 corresponding to the upper extending portion 24m. When the second mating member 300 presses the lower contact portion 223n upward, the reserved groove 113 and the inclined surface 1131 both provide clearance for the lower extending portion 24n.

Referring to FIGS. 22 and 23, a lower supporting portion 25n is formed by extending forward from the top portion of the lower through slot 23n. The lower supporting portion 25n includes a horizontally extending portion, and the horizontally extending portion occupies most of the lower supporting portion 25n. When the second mating member 300 abuts upward against the lower contact portion 223n, the lower abutting portion 241n abuts against the lower supporting portion 25n.

Referring to FIG. 23, the connecting portion 211 is a continuous plate-shaped structure. That is, the connecting portion 211 is not provided with any slot running therethrough in the front-rear direction. An upper end of the connecting portion 211 is connected to the upper supporting portion 25m, and a lower end of the connecting portion 211 is connected to the lower supporting portion 25n. The upper supporting portion 25m and the lower supporting portion 25n are provided to be vertically aligned.

Referring to FIGS. 22, 23 and 24, in the front-rear direction, the upper abutting portion 241m is located closer to the body portion 21 relative to the upper contact portion 223m, and the lower abutting portion 241n is located closer to the body portion 21 relative to the lower contact portion 223n. When the first mating member 200 abuts against the upper contact portion 223m to a final position and the second mating member 300 abuts against the lower contact portion 223n to a final position, viewing in the vertical direction, the upper abutting portion 241m is exposed in the upper through slot 23m, and the lower abutting portion 241n is exposed in the lower through slot 23n.

In sum, the electrical connector 100 according to certain embodiments of the present invention has the following beneficial effects:
(1) A projection of the upper abutting portion 241m in the front-rear direction is located within the upper through slot 23m, such that the upper through slot 23m provides clearance for the upper abutting portion 241m. If no upper through slot 23m were provided between the two upper branches 221m, in the process of the upper abutting portion 241m abutting against the upper supporting portion 25m, the upper abutting portion 241m may interfere with the upper elastic portion 22m, thus limiting the elastic deformation of the upper extending portion 24m and the upper elastic portion 22m. Further, the upper elastic portion 22m and the upper extending portion 24m are subjected to the pressure from the first mating member 200 and abut against each other, thus causing fatigue of the upper elastic portion 22m and the upper extending portion 24m due to the upper elastic portion 22m and the upper extending portion 24m being subjected to excessive normal forces. In the present invention, by providing the upper through slot 23m between the two upper branches 221m, and locating the projection of the upper abutting portion 241m within the upper through slot 23m, the upper through slot 23m provides clearance for the upper abutting portion 241m, thereby preventing interference between the upper abutting portion 241m and the upper elastic portion 22m.
(2) When the first mating member 200 abuts downward against the upper contact portion 223m to a final position, the impedance at the abutting position of the first mating member 200 and the upper contact portion 223m as well as the impedance at the abutting position of the upper abutting portion 241m and the upper supporting portion 25m are both relatively small. The first portion 2P includes the two sub-portions 2P1 separated in the left-right direction, such that the first portion 2P forms two conductive paths, thereby reducing the impedance of the first portion 2P. Further, in the left-right direction, a dimension of the first portion 2P is greater than dimensions of the upper contact portion 223m and the upper abutting portion 241m, thus further reducing the impedance of the first portion 2P, and thereby achieving impedance matching of the terminal 2.
(3) The upper supporting portion 25m extends in a horizontal direction. Compared with the case where the upper supporting portion 25m extends obliquely upward, a distance between the upper contact portion 223m and a tail end of the upper supporting portion 25m is greater, such that a length of the upper extending portion 24m may be longer, and the elasticity of the upper extending portion 24m is greater, thereby making the contact between the upper abutting portion 241m and the upper supporting portion 25m more stable. Further, when the first mating member 200 abuts downward against the upper contact portion 223m to the final position, the upper elastic portion 22m and the upper extending portion 24m bend to a greater extent, such that a height of the terminal 2 when abutting against the first mating member 200 to the final position is smaller, thereby reducing the height of the electrical connector 100.
(4) The connecting portion 211 is a continuous plate-shaped structure. That is, no through slot is provided in the connecting portion 211. An upper end of the connecting portion 211 is connected to the upper supporting portion 25m, and a lower end of the connecting portion 211 is connected to the lower supporting portion 25n. If a through slot is provided in the connecting portion 211, a current transmitted by the terminal 2 cannot be directly transmitted at the position of the slot, resulting in a relatively long transmission path of the current between the upper supporting portion 25m and the lower supporting portion 25n, which affects the signal integrity of the electrical connector 100. When the connecting portion 211 is a continuous plate-shaped structure, the current transmitted by the terminal 2 may be directly transmitted from the upper supporting portion 25m to the lower supporting portion 25n via the connecting portion 211, and a transmission path of the current between the upper supporting portion 25m and the lower supporting portion 25n is the shortest, thereby providing better signal integrity of the electrical connector 100. Further, the upper supporting portion 25m and the lower supporting portion 25n are provided to be vertically aligned, and the transmission path is more optimal, such that an overall structure of the terminal 2 is provided to be concentrated.
(5) In the left-right direction, a dimension of the upper abutting portion 241m is greater than a dimension of the upper contact portion 223m, and a dimension of the lower abutting portion 241n is greater than a dimension of the lower contact portion 223n. The upper contact portion 223m abuts against the first mating member 200, the lower contact portion 223n abuts against the second mating member 300, and impedances at the abutting positions are relatively small. The dimension of the upper abutting portion 241m is greater than the dimension of the upper contact portion 223m, and the dimension of the lower abutting portion 241n is greater than the dimension of the lower contact portion 223n, thus reducing the impedances of the upper abutting portion 241m and the lower abutting portion 241n, and thereby achieving impedance matching of the terminal 2.
(6) In the front-rear direction, the upper abutting portion 241m is located closer to the body portion 21 relative to the upper contact portion 223m, and the lower abutting portion 241n is located closer to the body portion 21 relative to the lower contact portion 223n. Compared with the case where the upper abutting portion 241m is located farther from the body portion 21 relative to the upper contact portion 223m, and the lower abutting portion 241n is located farther from the body portion 21 relative to the lower contact portion 223n, in the present invention, a dimension of the terminal 2 in the front-rear direction may be smaller. On the premise that a volume of the main body 1 remains unchanged, the density of the terminals 2 may be higher, which is suitable for an electrical connector 100 with higher density of the terminals 2 and higher-frequency performance.
(7) Two slots 212 are provided at the left side and the right side of the body portion 21 running therethrough in the front-rear direction. The two slots 212 increase the elasticity of the left side and the right side of the body portion 21, and the left side and the right side of the body portion 21 may elastically deform more easily, thus facilitating assembly of the terminal 2 into the corresponding accommodating slot 11. In addition, the connecting portion 211 is located between the two slots 212, and the two slots 212 do not communicate with each other, thus allowing a transmission path of the current between the upper supporting portion 25m and the lower supporting portion 25n to be the shortest.
(8) The connecting portion 211 is a continuous plate-shaped structure, so the elasticity of the connecting portion 211 is relatively poor. The connecting portion 211 is located between the upper and lower boundaries of the slots 212 in the vertical direction, thus more effectively increasing the elasticity of the left side and the right side of the body portion 21, thereby facilitating assembly of the terminal 2 into the corresponding accommodating slot 11.
(9) The two bending portions 251 are provided at an interval in the left-right direction to form the opening 252, such that a space exists between the two bending portions 251 to form a pushing portion 2g therein. The pushing portion 2g is formed by extending upward from a bottom portion of the opening 252, and it is unnecessary to additionally provide the pushing portion 2g at another position of the terminal 2, thereby saving space of the terminal 2. In the left-right direction, the pushing portion 2g and the two bending portions 251 stop each other, thereby limiting deviation of the bending portions 251 in the left-right direction, and further ensuring that an abutting position of the upper supporting portion 25m and the upper abutting portion 241m is accurate.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
a main body, comprising a plurality of accommodating slots running through the main body along a vertical direction; and
a plurality of terminals, respectively accommodated correspondingly in the accommodating slots, wherein each of the terminals comprises:
an upper elastic portion, wherein a top portion of the upper elastic portion has an upper contact portion, and the upper contact portion is configured to upwardly abut against a first mating member;
an upper through slot, at least partially located in the upper elastic portion, such that the upper elastic portion forms two upper branches separated by the upper through slot in a left-right direction;
an upper extending portion, formed by bending and extending downward from the upper contact portion, wherein an upper abutting portion is formed at an end portion of the upper extending portion away from the upper contact portion; and
an upper supporting portion, located below the upper contact portion, wherein when the first mating member abuts downward against the upper contact portion, the upper abutting portion abuts against the upper supporting portion;
wherein a projection of the upper abutting portion in a front-rear direction is located in the upper through slot, such that the upper through slot is reserved for the upper abutting portion.

2. The electrical connector according to claim 1, wherein the upper extending portion includes a first portion and a second portion, in the left-right direction, a dimension of the first portion is greater than a dimension of the second portion, the upper abutting portion is located on the second portion, and the first portion comprises two sub-portions separated in the left-right direction and a slot located between the two sub-portions.

3. The electrical connector according to claim 1, wherein the upper elastic portion further comprises an upper shoulder portion connecting top ends of the two upper branches, the upper contact portion is formed by extending from the upper shoulder portion, and in the left-right direction, a dimension of the upper shoulder portion is greater than a maximum dimension limited between the two upper branches.

4. The electrical connector according to claim 1, wherein the upper elastic portion further comprises an upper shoulder portion connecting top ends of the two upper branches, the upper contact portion is formed by extending from the upper shoulder portion, and the upper shoulder portion protrudes toward the upper through slot to form a protruding portion.

5. The electrical connector according to claim 1, wherein each of the terminals further comprises a body portion, the upper elastic portion is formed by bending from an upper end of the body portion and then extending upward, the upper elastic portion firstly extends upward and backward and then extends upward and forward, the main body is provided with a stopping block corresponding to at least one of the accommodating slots, the stopping block is located behind the body portion of a corresponding one of the terminals, and the stopping block extends into the upper through slot of the corresponding one of the terminals.

6. The electrical connector according to claim 1, wherein each of the terminals further comprises a base portion, a body portion is formed by bending and extending from a rear end of the base portion, a supporting plate is formed by bending and extending from a front end of the base portion, the body portion and the supporting plate are provided facing each other in the front-rear direction, the upper elastic portion is formed by bending from an upper end of the body portion and then extending upward, the upper supporting portion is formed by bending from an upper end of the supporting plate and then extending backward, and when the first mating member abuts downward against the upper contact portion to a final position, compared to an end of the upper supporting portion connected to the supporting plate, an abutting position of the upper abutting portion and the upper supporting portion is closer to a tail end of the upper supporting portion away from the supporting plate.

7. The electrical connector according to claim 6, wherein a guiding portion is formed by obliquely extending from an upper end or a lower end of the base portion toward a side where the body portion and the supporting plate are located, a hook portion is formed at a tail end of the guiding portion, the main body is provided with two limiting blocks in each of the accommodating slots, the two limiting blocks are located at a front side and a rear side of the guiding portion, and the two limiting blocks match with the hook portion to limit a corresponding one of the terminals from moving upward or downward.

8. The electrical connector according to claim 1, wherein each of the terminals further comprises a body portion, the upper elastic portion is formed by bending from an upper end of the body portion and then extending upward, in the front-rear direction, the upper contact portion is located in front of the body portion, the upper supporting portion is formed by bending from the upper end of the body portion and then extending backward, and the upper abutting portion passes through the upper through slot to abut against the upper supporting portion.

9. The electrical connector according to claim 8, wherein in the front-rear direction, a distance between a tail end of the upper supporting portion and the body portion is greater than a distance between a tail end of the upper abutting portion and the body portion.

10. The electrical connector according to claim 1, wherein each of the terminals further comprises a body portion, the upper elastic portion is formed by bending from an upper end of the body portion and then extending upward, the upper abutting portion is located closer to the body portion relative to the upper contact portion, and when the first mating member abuts against the upper contact portion to a final position, viewing from the vertical direction, the upper abutting portion is exposed in the upper through slot.

11. An electrical connector, comprising:
a main body, comprising a plurality of accommodating slots running through the main body along a vertical direction; and
a plurality of terminals, respectively accommodated correspondingly in the accommodating slots, wherein each of the terminals comprises:
a body portion, provided in a corresponding one of the accommodating slots;
an upper elastic portion, formed by extending upward from the body portion, wherein a top portion of the upper elastic portion has an upper contact portion, the upper contact portion is located in front of the body portion, and the upper contact portion is configured to upwardly abut against a first mating member;
an upper extending portion, formed by bending and extending downward from the upper contact portion, wherein an upper abutting portion is formed at an end portion of the upper extending portion away from the upper contact portion;
an upper through slot, provided at least in the upper elastic portion;
an upper supporting portion, formed by extending from a bottom portion of the upper through slot, wherein when the first mating member abuts downward against the upper contact portion, the upper abutting portion abuts against the upper supporting portion;
a lower elastic portion, formed by extending downward from the body portion, wherein a bottom portion of the lower elastic portion has a lower contact portion, the lower contact portion is located in front of the body portion, and the lower elastic portion is configured to downwardly abut against a second mating member;
a lower extending portion, formed by bending and extending upward from the lower contact portion, wherein a lower abutting portion is formed at an end portion of the lower extending portion away from the lower contact portion;
a lower through slot, provided at least in the lower elastic portion; and
a lower supporting portion, extending from a top portion of the lower through slot, wherein when the second mating member abuts upward against the lower contact portion, the lower abutting portion abuts against the lower supporting portion;
wherein each of the upper supporting portion and the lower supporting portion at least partially extends in the front-rear direction relative to the body portion, the body portion comprises a connecting portion, an upper end of the connecting portion is connected to the upper supporting portion, a lower end of the connecting portion is connected to the lower supporting portion, and the connecting portion is a continuous plate-shaped structure.

12. The electrical connector according to claim 11, wherein in the left-right direction, a dimension of the upper abutting portion is greater than a dimension of the upper contact portion, and a dimension of the lower abutting portion is greater than a dimension of the lower contact portion.

13. The electrical connector according to claim 11, wherein each of the upper supporting portion and the lower supporting portion has a horizontally extending portion, the upper abutting portion is configured to abut against the horizontally extending portion of the upper supporting portion, the lower abutting portion is configured to abut against the horizontally extending portion of the lower supporting portion, and the upper supporting portion and the lower supporting portion are provided to be vertically aligned.

14. The electrical connector according to claim 11, wherein the upper through slot and the lower through slot respectively extend to the body portion, and the body portion is a flat plate structure.

15. The electrical connector according to claim 11, wherein each of the terminals further comprises at least one pushing portion, viewing downward, the pushing portion is exposed in the upper through slot, a portion of the upper supporting portion extends horizontally, and a highest point of the pushing portion is provided to be higher than the upper supporting portion.

16. The electrical connector according to claim 15, wherein each of the terminals comprises two pushing portions located at a left side and a right side of the upper supporting portion, the pushing portions are sharp-angle shaped, the upper supporting portion is concavely provided with two notches, the two notches are respectively located at the left side and the right side of the upper supporting portion, and before each of the terminals is formed, on the same side of the upper supporting portion, each of the notches is connected to a corresponding one of the two pushing portions.

17. The electrical connector according to claim 11, wherein the upper supporting portion comprises two bending portions formed by bending and extending from a bottom portion of the upper through slot and a horizontal portion linearly extending from the two bending portions and connecting the two bending portions, each of the terminals further comprises a pushing portion extending from the bottom portion of the upper through slot, the pushing portion is located between the two bending portions, and in the left-right direction, the pushing portion and the bending portions stop each other.

18. The electrical connector according to claim 11, wherein in the front-rear direction, the upper abutting portion is located closer to the body portion relative to the upper contact portion, the lower abutting portion is located closer to the body portion relative to the lower contact portion, and when the first mating member abuts against the upper contact portion to a final position, viewing from the vertical direction, the upper abutting portion is exposed in the upper through slot, the lower abutting portion is exposed in the lower through slot, a projection of the upper abutting portion in the front-rear direction is located within the upper through slot, and a projection of the lower abutting portion in the front-rear direction is located within the lower through slot.

19. An electrical connector, comprising:
a main body, comprising a plurality of accommodating slots running through the main body along a vertical direction; and
a plurality of terminals, respectively accommodated correspondingly in the accommodating slots, wherein each of the terminals comprises:
a body portion, fixed in a corresponding one of the accommodating slots;
an upper elastic portion, formed by extending upward from the body portion, wherein a top portion of the upper elastic portion has an upper contact portion, the upper contact portion is located in front of the body portion, and the upper contact portion is configured to upwardly abut against a first mating member;
an upper through slot, provided at least in the upper elastic portion, and running through the upper elastic portion so as to divide the upper elastic portion into two upper branches in the left-right direction;
an upper extending portion, formed by bending and extending downward from the upper contact portion, wherein an upper abutting portion is formed at an end portion of the upper extending portion away from the upper contact portion; and
an upper supporting portion, formed by extending from a bottom portion of the upper through slot, wherein the upper supporting portion is located below the upper contact portion, and when the first mating member abuts downward against the upper contact portion, the upper abutting portion abuts against the upper supporting portion;
wherein each of the terminals is provided with a pushing portion, the pushing portion is provided to be lower than a top portion of the upper through slot and higher than the bottom portion of the upper through slot, the pushing portion is exposed upward in the upper through slot, and the pushing portion is configured to be pushed by a jig so as to adjust a position of each of the terminals in a corresponding one of the accommodating slots.

20. The electrical connector according to claim 19, wherein the upper supporting portion at least partially extends in the front-rear direction relative to the body portion, and the pushing portion is provided on the upper supporting portion.
